(19) United States
(12) Patent Application Publication
(10) Pub. No.: US 2006/0114558 A1
(43) Pub. Date: Jun. 1, 2006

(54) Member with concave portions, a method of manufacturing a member with convex portions, a transmission screen, and a rear projection

(76) Inventor: Nobuo Shimizu, Suwa-shi (JP)

Correspondence Address: HARNESS, DICKEY & PIERCE, P.L.C., P.O. BOX 828, BLOOMFIELD HILLS, MI, 48303, US

(21) Appl. No.: 11/262,994

(22) Filed: Oct. 31, 2005

(30) Foreign Application Priority Data
Nov. 2, 2004 (JP) 2004-319834

(51) Int. Cl. G03B 21/60; G03B 21/56

(52) U.S. Cl. 359/457; 359/460

(57) ABSTRACT

A member 6 with concave portions used to manufacture a member with convex portions is disclosed. Each of the member with concave portions and the member with convex portions has two major surfaces, and a plurality of convex portions are formed on one of the two major surfaces of the member with convex portions. The member 6 with concave portions includes: a first region 67 provided on one of the two major surfaces of the member 6 with concave portions, a plurality of first concave portions 61 being formed in the first region 67 and used to form the plurality of convex portions of the member with convex portions; and a second region 68 provided on the one major surface of the member 6 with concave portions, the second region 68 being located adjacent to the first region 67, a plurality of second concave portions 62 being formed in the second region 68, the depth of each of the plurality of second concave portions 62 being shallower than the depth of each of the plurality of first concave portions 61.

### CROSS-REFERENCE TO RELATED APPLICATION

This application claims priority to Japanese Patent Application No. 2004-319834 filed Nov. 2, 2004, which is hereby expressly incorporated by reference herein in its entirety.

### FIELD OF THE INVENTION

The present invention relates to a member with concave portions, a method of manufacturing a member with convex portions, a transmission screen, and a rear projection.

### BACKGROUND OF THE INVENTION

In recent years, demand for a rear projection is becoming increasingly strong as a suitable display for a monitor for a home theater, a large screen television, or the like. In a transmission screen used for the rear projector, a lens substrate provided with a plurality of lenses is in general use. Heretofore, a lenticular lens substrate provided with lenticular lenses is generally used as thee lens substrate. However, a conventional rear projection provided with such a lenticular lens substrate has a problem that the vertical angle of view thereof is small although the lateral angle of view thereof is large (this is, there is a bias in the angles of view). In order to solve such a problem, an attempt to use a microlens sheet (microlens substrate) on which a plurality of microlenses are formed so that concave portions or convex portions have optically rotational symmetry has been proposed (for example, see JP-A-2000-131506).

The lens sheet (in particular, microlens substrate) as described above has been conventionally manufactured using a method (for example, so-called 2P method). In the 2P method, a uncured resin is supplied onto a substrate provided with a plurality of concave portions for forming a plurality of lenses, the surface shape of the substrate with concave portions is transferred to the supplied resin (for example, see JP-A-2003-279949).

However, in the 2P method as described above, there is a problem that it is difficult to release the cured resin from the substrate with concave portions. Further, such a problem becomes more remarkable in the case of manufacturing a lens substrate (microlens substrate) provided with microlenses as lenses, in the case where the size of each of lenses to be formed is small (that is, each of lenses has a minute structure), in the case where the microlens substrate has a large number of lenses, in the case where the lenses are formed in the microlens substrate in high density manner (for example, 1000 pieces/cm² or more), in the case where the lens substrate to be manufactured has a large area (for example, a substrate having a diagonal length thereof of 60 cm or more), or the like. It is thought that this is because a minute pattern formed on the surface of the substrate with concave portions becomes a state where it clings to a lens substrate to be manufactured due to the anchor effect.

Further, there has been a problem that defects such as crack are generated in the substrate with concave portions and/or any convex portions (convex lenses) of the lens substrate to be formed by means of transfer when the substrate with concave portions is to be removed from the lens substrate forcibly. Thus, for the reason described above, there has also been a problem that yield of the lens substrate is made to lower extremely.

### SUMMARY OF THE INVENTION

It is one object of the invention to provide a member with concave portions that can be appropriately used to manufacture a member with convex portions each having a desired shape.

It is another object of the invention to provide a method of manufacturing a member with convex portions by which the member with convex portions each having a desired shape can be manufactured easily and surely.

It is yet another object of the invention to provide the member with concave portions.

Further, it is still another object of the invention to provide a transmission screen and a rear projection provided with the member with convex portions.

In order to achieve the above objects, in one aspect of the invention, the invention is directed to a member with concave portions used to manufacture a member with convex portions. Each of the member with concave portions and the member with convex portions has two major surfaces, and a plurality of convex portions are formed on one of the two major surfaces of the member with convex portions. The member with concave portions of the invention includes:

a first region provided on one of the two major surfaces of the member with concave portions, a plurality of first concave portions being formed in the first region and used to form the plurality of convex portions of the member with convex portions; and

a second region provided on the one major surface of the member with concave portions, the second region being located adjacent to the first region, a plurality of second concave portions being formed in the second region, the depth of each of the plurality of second concave portions being shallower than the depth of each of the plurality of first concave portions.

This makes it possible to provide a member with concave portions that can be appropriately used to manufacture a member with convex portions each having a desired shape. More specifically, it is possible to prevent defects such as crack from being generated in the member with concave portions and/or any convex portions to be formed of the member with convex portions efficiently when releasing the member with convex portions from the member with concave portions in manufacturing the member with convex portions.

In the member with concave portions of the invention, it is preferable that the member with convex portions is a microlens substrate provided with a plurality of microlenses formed from the plurality of convex portions.

This makes it possible to use the member with convex portions to be manufactured using the member with concave portions as, for example, a component (that is, microlens substrate) of a transmission screen and/or a rear projection appropriately. Further, it is easy to generate disadvantage such as crack in a member with concave portions and/or any convex portions (microlenses) to be formed particularly in the case where the member with convex portions to be manufactured in a conventional method is a microlens substrate. However, according to the invention, it is possible to prevent various problems from being generated effectively even in manufacturing a microlens substrate. In other words, in the case where the member with concave portion of the invention is applied to manufacture of the microlens substrate, the effects of the invention are achieved remarkably, in particular.

In the member with concave portions of the invention, it is preferable that the depth of each of the plurality of first concave portions is in the range of 8 to 500 μm.

This makes it possible to prevent defects such as crack from being generated in the member with concave portions and/or any convex portions to be formed of the member with convex portions more efficiently when releasing the member with convex portions from the member with concave portions in manufacturing the member with convex portions. Further, it is possible to improve angle of view characteristics of a screen provided with the member with convex portions to be manufactured particularly in the case of, for example, using the member with convex portions as a lens substrate (microlens substrate).

In the member with concave portions of the invention, it is preferable that the depth of each of the plurality of second concave portions is in the range of 5 to 400 μm.

This makes it possible to prevent defects such as crack from being generated in the member with concave portions and/or any convex portions to be formed of the member with convex portions still more efficiently when releasing the member with convex portions from the member with concave portions in manufacturing the member with convex portions.

In the member with concave portions of the invention, it is preferable that, in the case where the depth of each of the plurality of first concave portions is defined as D₁ (μm) and the depth of each of the plurality of second concave portions is defined as D₂ (μm), then D₁ and D₂ satisfy the relation: 3≦D₁−D₂≦495.

This makes it possible to prevent defects such as crack from being generated in the member with concave portions and/or any convex portions to be formed of the member with convex portions more efficiently when releasing the member with convex portions from the member with concave portions in manufacturing the member with convex portions.

In the member with concave portions of the invention, it is preferable that each of the plurality of first concave portions has a substantially elliptic shape in which a length thereof in a long axis direction is longer than a length thereof in a short axis direction perpendicular to the long axis direction when viewed from above the one major surface of the member with concave portions.

This makes it possible to prevent defects such as crack from being generated in the member with concave portions and/or any convex portions to be formed of the member with convex portions more efficiently when releasing the member with convex portions from the member with concave portions in manufacturing the member with convex portions. Further, it is possible to improve angle of view characteristics of a screen provided with the member with convex portions to be manufactured while preventing moire from being generated due to interference of light in the case of, for example, using the member with convex portions as a lens substrate (microlens substrate).

In the member with concave portions of the invention, it is preferable that the member with concave portions is formed of a material having transparency.

Thus, for example, in the case where the member with concave portions is used to manufacture a microlens substrate, it is possible to appropriately carry out processes such as formation of a black matrix without removing the member with concave portions from the member with convex portions (microlens substrate). As a result, it is possible to improve light use efficiency of a transmission screen provided with the microlens substrate to be manufactured particularly.

In the member with concave portions of the invention, it is preferable that, in the case where the length of each of the first concave portions in the short axis direction thereof is defined as L₁ (μm) and the length of each of the first concave portions in the long axis direction thereof is defined as L₂ (μm), then L₁ and L₂ satisfy the relation: 0.10≦L₁/L₂≦0.99.

This makes it possible to prevent defects such as crack from being generated in the member with concave portions and/or any convex portions to be formed of the member with convex portions still more efficiently when releasing the member with convex portions from the member with concave portions in manufacturing the member with convex portions. Further, it is possible to improve angle of view characteristics of a screen provided with the member with convex portions to be manufactured while preventing moire from being generated due to interference of light in the case of, for example, using the member with convex portions as a lens substrate (microlens substrate).

In another aspect of the invention, the invention is directed to a method of manufacturing a member with convex portions. The member with convex portions is manufactured using the member with concave portions described above.

This makes it possible to provide a method of manufacturing a member with convex portions by which the member with convex portions each having a desired shape can be manufactured easily and surely. More specifically, it is possible to manufacture the member with convex portions while preventing defects such as crack from being generated in the member with concave portions and/or any convex portions to be formed of the member with convex portions efficiently when releasing the member with convex portions from the member with concave portions.

In the method of manufacturing a member with convex portions of the invention, it is preferable that the method includes the steps of:

preparing the member with concave portions;

supplying a resin material having fluidity onto one major surface of the member with concave portions on which the plurality of concave portions are formed;

solidifying the resin material to form a base member; and

releasing the base member from the member with concave portions.

This makes it possible to manufacture the member with convex portions while preventing defects such as crack from being generated in the member with concave portions and/or any convex portions to be formed of the member with convex portions more efficiently when releasing the member with convex portions from the member with concave portions.

In the method of manufacturing a member with convex portions of the invention, it is preferable that the base member releasing step includes the steps of:

releasing the base member from the second region of the member with concave portions; and

removing the base member from the first region of the member with concave portions.

This makes it possible to manufacture the member with convex portions while preventing defects such as crack from being generated in the member with concave portions and/or any convex portions to be formed of the member with convex portions still more efficiently when releasing the member with convex portions from the member with concave portions.

In still another aspect of the invention, the invention is directed to a member with convex portions manufactured using the method of manufacturing a member with convex portions described above.

This makes it possible to provide a member with convex portions each having a desired shape (to which the surface shape of the member with concave portions is truly transferred).

In the member with convex portions of the invention, it is preferable that the member with convex portions is formed of a material having transparency.

This makes it possible to use the member with convex portions as, for example, a component (lens substrate) of a transmission screen and/or a rear projection appropriately.

In yet another aspect of the invention, the invention is directed to a transmission screen. The transmission screen of the invention includes:

a Fresnel lens formed with a plurality of concentric prisms on one major surface thereof, the one major surface of the Fresnel lens constituting an emission surface thereof; and

the member with convex portions described above, the member with convex portions being arranged on the side of the emission surface of the Fresnel lens so that one major surface thereof on which the plurality of convex portions have been formed faces the Fresnel lens.

This makes it possible to provide a transmission screen in which problems of the image to be projected due to defects of any lenses can be prevented from being generated effectively.

In yet still another aspect of the invention, the invention is directed to a rear projection. The rear projection of the invention includes the transmission screen described above.

This makes it possible to provide a rear projection in which problems of the image to be projected due to defects of any lenses can be prevented from being generated effectively.

### BRIEF DESCRIPTION OF THE DRAWINGS

The foregoing and other objects, features and advantages of the invention will become more readily apparent from the following detailed description of preferred embodiment of the invention which proceeds with reference to the appending drawings.

FIG. 1 is a longitudinal cross-sectional view which schematically shows a microlens substrate (member with convex portions) in a preferred embodiment according to the invention.

FIG. 2 is a plan view of the microlens substrate shown in FIG. 1.

FIG. 3 is a longitudinal cross-sectional view which schematically shows a transmission screen provided with the microlens substrate shown in FIG. 1 in a preferred embodiment according to the invention.

FIG. 4 is a plan view which schematically shows a member with concave portions in an embodiment of the invention.

FIGS. 5A and 5B are a partially enlarged view and a longitudinal cross-sectional view of the member with concave portions shown in FIG. 4, respectively.

FIG. 6 is a longitudinal cross-sectional view which schematically shows a method of manufacturing the member with concave portions shown in FIGS. 4 and 5.

FIG. 7 is a longitudinal cross-sectional view which schematically shows one example of a method of manufacturing a lens substrate (microlens substrate) shown in FIG. 1.

FIG. 8 is a drawing which schematically shows the configuration of a rear projection to which the transmission screen of the invention is applied.

### DETAILED DESCRIPTION OF THE INVENTION

Preferred embodiment of a member with concave portions, a method of manufacturing a member with convex portions, a transmission screen, and a rear projection according to the invention will now be described in detail with reference to the appending drawings.

In this regard, in the invention, a “substrate” indicates a concept that includes one having a relatively large wall thickness and substantially no flexibility, sheet-shaped one, film-shaped one, and the like. Further, although application of the member with concave portions and the member with convex portions and the like of the invention is not particularly limited, in the present embodiment, a description will be given for the case where the member with convex portions is mainly used as a microlens substrate (convex lens substrate) included in a transmission screen and/or a rear projection, and the member with concave portions is mainly used as a mold to manufacture the microlens substrate as described above (member with concave portions for manufacturing a microlens substrate).

First, prior to the description of a member with concave portions and a method of manufacturing a member with convex portions according to the invention, the configuration of a microlens substrate (member with convex portions) of the invention will be described.

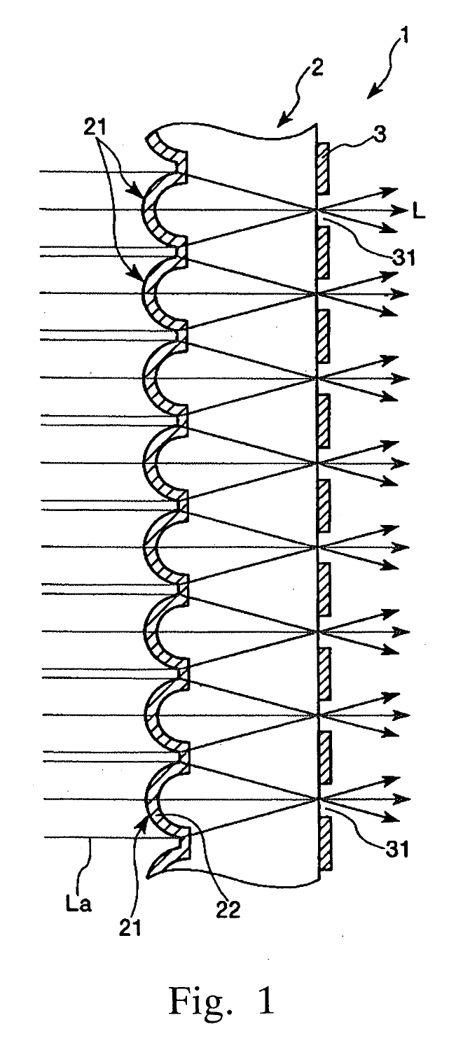

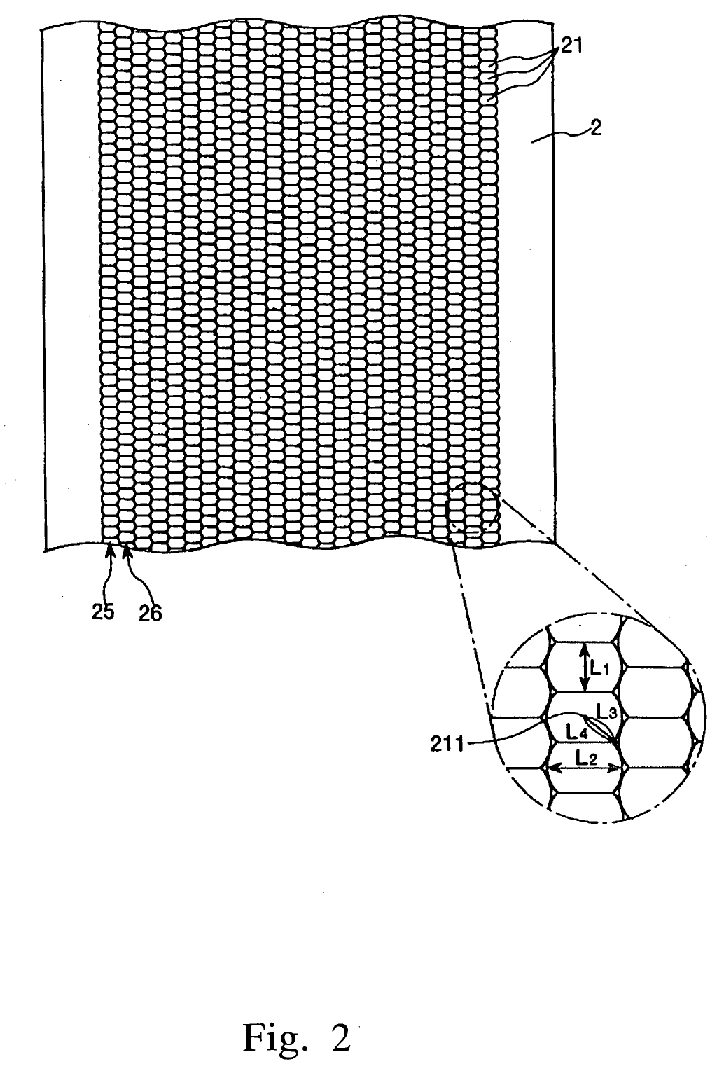

FIG. 1 is a longitudinal cross-sectional view which schematically shows a microlens substrate (member with convex portions) 1 in a preferred embodiment according to the invention. FIG. 2 is a plan view of the microlens substrate 1 shown in FIG. 1. Now, in the following explanation using FIG. 1, for convenience of explanation, a left side and a right side in FIG. 1 are referred to as a “light incident side (or light incident surface)” and a “light emission side (or light emission surface)”, respectively. In this regard, in the following description, a “light incident side” and a “light emission side” respectively indicate a “light incident side” and a “light emission side” of light for obtaining an image light, and they do not respectively indicate a “light incident side” and a “light emission side” of outside light or the like if not otherwise specified.

The microlens substrate (member with convex portions) 1 is a member that is included in a transmission screen 10 described later. As shown in FIG. 1, the microlens substrate 1 includes: a main substrate 2 provided with a plurality of microlenses (convex portions) 21 in a predetermined pattern at one major surface thereof (light incident surface); and a black matrix (light shielding layer) 3 formed of a material having light shielding effect at the other major surface thereof (light emission surface). Further, the microlens substrate 1 is provided with a coloring portion (outside light absorbing portion) 22 at the light incident surface thereof (that is, the light incident side of each of the microlenses 21).

The main substrate 2 is generally constituted from a material having transparent. The constituent material of the main substrate 2 is not particularly limited, but the main substrate 2 is composed of a resin material as a main material. The resin material is a transparent material having a predetermined index of refraction.

As for the concrete constituent material of the main substrate 2, for example, polyolefin such as polyethylene, polypropylene, ethylene-propylene copolymer, ethylene-vinyl acetate copolymer (EVA) and the like, cyclic polyolefin, denatured polyolefin, polyvinyl chloride, polyvinylidene chloride, polystyrene, polyamide (such as nylon 6, nylon 46, nylon 66, nylon 610, nylon 612, nylon 11, nylon 12, nylon 6-12, nylon 6-66), polyimide, polyamide-imide, polycarbonate (PC), poly-(4-methylpentene-1), ionomer, acrylic resin, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyester such as polyethylene terephthalate (PET), polybutylene terephthalate (PBT), and polycyclohexane terephthalate (PCT), polyether, polyether ketone (PEK), polyether ether ketone (PEEK), polyether imide, polyacetal (POM), polyphenylene oxide, denatured polyphenylene oxide, polysulfone, polyether sulfone, polyphenylene sulfide, polyarylate, liquid crystal polymer such as aromatic polyester, fluoro resins such as polytetrafluoroethylene (PTFE), polyfluorovinylidene and the like, various thermoplastic elastomers such as styrene based elastomer, polyolefin based elastomer, polyvinylchloride based elastomer, polyurethane based elastomer, polyester based elastomer, polyamide based elastomer, polybutadiene based elastomer, trans-polyisoprene based elastomer, fluorocarbon rubber based elastomer, chlorinated polyethylene based elastomer and the like, epoxy resins, phenolic resins, urea resins, melamine resins, unsaturated polyester, silicone based resins, urethane based resins, and the like; and copolymers, blended bodies and polymer alloys and the like having at least one of these materials as a main ingredient may be mentioned. Further, in this invention, a mixture of two or more kinds of these materials may be utilized (for example, a blended resin, a polymer alloy, a laminate body comprised of two or more layers using two or more of the materials mentioned above).

The resin material constituting the main substrate 2 normally has an absolute index of refraction more than each of those of various gases (that is, atmosphere at which the microlens substrate 1 is used). It is preferable that the concrete absolute index of refraction of the resin material is in the range of 1.2 to 1.9. More preferably it is in the range of 1.35 to 1.75, and further more preferably it is in the range of 1.45 to 1.60. In the case where the absolute index of refraction of the resin material has a predetermined value within the above range, it is possible to further improve the angle of view characteristics of a transmission screen 10 provided with the microlens substrate 1 while keeping the light use efficiency of the transmission screen 10.

The microlens substrate 1 is provided with the plurality of microlenses 21 each having a convex surface as a convex lens on the side of the light incident surface thereof from which the light is allowed to enter the microlens substrate 1. In the present embodiment, each of the microlenses 21 has a flat shape (in this case, such a shape includes a substantially elliptic shape, a substantial bale shape, and a shape in which the top and bottom portions of a substantially circular shape are cut) in which a longitudinal width thereof is larger than a lateral width when viewed from above the light incident surface of the microlens substrate 1. In the case where each of the microlenses 21 has such a shape, it is possible to particularly improve the angle of view characteristics of the transmission screen 10 provided with the microlens substrate 1 while preventing disadvantage such as moire from being generated efficiently. In particular, in this case, it is possible to improve the angle of view characteristics in both the horizontal and vertical directions of the transmission screen 10 provided with the microlens substrate 1.

In the case where the length (or pitch) of each of the microlenses 21 in a short axis (or minor axis) direction thereof is defined as L₁ (μm) and the length (or pitch) of each of the microlenses 21 in a long axis (or major axis) direction thereof is defined as L₂ (μm) when viewed from above the light incident surface of the microlens substrate 1, it is preferable that the ratio of L₁/L₂ is in the range of 0.10 to 0.99 (that is, it is preferable that L₁ and L₂ satisfy the relation: 0.10≦L₁/L₂≦0.99). More preferably it is in the range of 0.50 to 0.95, and further more preferably it is in the range of 0.60 to 0.80. By restricting the ratio of L₁/L₂ within the above range, the effect described above can become apparent.

It is preferable that the length (or pitch) L₁ of each of the microlenses 21 in the minor axis direction when viewed from above the light incident surface of the microlens substrate 1 is in the range of 10 to 500 μm. More preferably it is in the range of 30 to 300 μm, and further more preferably it is in the range of 50 to 100 μm. In the case where the length of each of the microlenses 21 in the minor axis direction is restricted within the above range, it is possible to obtain sufficient resolution in the image projected on the transmission screen 10 and further enhance the productivity of the microlens substrate 1 (including the transmission screen 10) while preventing disadvantage such as moiré from being generated efficiently.

Further, it is preferable that the length (or pitch) L₂ of each of the microlenses 21 in the major axis direction when viewed from above the light incident surface of the microlens substrate 1 is in the range of 15 to 700 μm. More preferably it is in the range of 40 to 400 μm, and further more preferably it is in the range of 70 to 150 μm. In the case where the length of each of the microlenses 21 in the major axis direction is restricted within the above range, it is possible to obtain sufficient resolution in the image projected on the transmission screen 10 and further enhance the productivity of the microlens substrate 1 (including the transmission screen 10) while preventing disadvantage such as moiré from being generated efficiently.

Moreover, it is preferable that the radius of curvature of each of the microlenses 21 in the minor axis direction thereof (hereinafter, referred to simply as “radius of curvature of the microlens 21” is in the range of 5 to 150 μm. More preferably it is in the range of 15 to 150 μm, and further more preferably it is in the range of 25 to 50 μm. By restricting the radius of curvature of the microlens 21 within the above range, it is possible to improve the angle of view characteristics of the transmission screen 10 provided with the microlens substrate 1. In particular, in this case, it is possible to improve the angle of view characteristics in both the horizontal and vertical directions of the transmission screen 10 provided with the microlens substrate 1.

Furthermore, in the case where the height of each of the microlenses 21 is defined as H (μm) and the length of each of the microlenses 21 in a short axis (or minor axis) direction thereof is defined as L₁ (μm), then H and L₁ satisfy the relation: 0.20≦L₁/H≦2.40. More preferably H and L₁ satisfy the relation: 0.5≦L₁/H≦1.9, and further more preferably H and L₁ satisfy the relation: 0.9≦L₁/H≦1.4. In the case where H and L₁ satisfy such a relation, it is possible to improve the angle of view characteristics particularly while preventing moire due to interfere of light from being generated effectively.

Further, the plurality of microlenses 21 are arranged on the main substrate 2 in a houndstooth check manner. By arranging the plurality of microlenses 21 in this way, it is possible to prevent disadvantage such as moire from being generated effectively. On the other hand, for example, in the case where the microlenses 21 are arranged on the main substrate 2 in a square lattice manner or the like, it is difficult to prevent disadvantage such as moire from being generated sufficiently. Further, in the case where the microlenses 21 are arranged on the main substrate 2 in a random manner, it is difficult to improve the share of the microlenses 21 in a usable area in which the microlenses 21 are formed sufficiently, and it is difficult to improve light transmission into the microlens substrate 1 (light use efficiency) sufficiently. In addition, the obtained image becomes dark.

In the present embodiment, although the microlenses 21 are arranged on the main substrate 2 in a houndstooth check manner when viewed from above one major surface of the microlens substrate 1 as described above, it is preferable that a first column 25 constituted from a plurality of microlenses 21 is shifted by a half pitch with respect to a second column 26 adjacent to the first column 25. This makes it possible to improve the angle of view characteristics particularly while preventing moire due to interfere of light from being generated effectively.

As described above, by specifying the shape of each of the microlenses (convex portions) 21, the arrangement pattern of the microlenses 21, share of the microlenses 21, and the like strictly, it is possible to improve the angle of view characteristics particularly while preventing the moire due to interfere of light from being generated effectively.

Moreover, each of the microlenses 21 is formed as a convex lens which protrudes toward the light incident side thereof, and is designed so that the focal point f thereof is positioned in the vicinity of each of openings 31 provided on the black matrix (light shielding layer) 3. In other words, parallel light La that enters the microlens substrate 1 from a direction substantially perpendicular to the microlens substrate 1 (parallel light La from a Fresnel lens 5 described later) is condensed by each of the microlenses 21 of the microlens substrate 1, and is focused on the focal point f in the vicinity of each of openings 31 provided on the black matrix (light shielding layer) 3. In this way, since the light passing through each of the microlenses 21 focuses in the vicinity of each of the openings 31 of the black matrix 3, it is possible to enhance the light use efficiency of the microlens substrate 1 particularly. Further, since the light passing through each of the microlenses 21 focuses in the vicinity of each of the openings 31, it is possible to reduce the area of each of the openings 31.

Further, it is preferable that the ratio of an area (projected area) occupied by all the microlenses 21 in a usable area (that is, usable lens area) where the microlenses 21 are formed with respect to the entire usable area is 90% or more when viewed from above the light incident surface of the microlens substrate 1 (that is, a direction shown in FIG. 2). More preferably the ratio is 96% or more, further more preferably the ratio is in the range of 97 to 99.5%. In the case where the ratio of the area occupied by all the microlenses (convex lenses) 21 in the usable area with respect to the entire usable area is 90% or more, it is possible to reduce straight light passing through an area other than the area where the microlenses 21 reside, and this makes it possible to enhance the light use efficiency of the transmission screen 10 provided with the microlens substrate 1 further. In this regard, in the case where the length of one microlens 21 in a direction from the center of the one microlens 21 to the center of a non-formed area on which the four adjacent microlenses 2 including the one microlens 2 are not formed is defined as L₃ (μm) and the length between the center of the one microlens 21 and the center of the non-formed area is defined as L₄ (μm) when viewed from above the light incident surface of the microlens substrate 1, the ratio of an area (projected area) occupied by all the microlenses 21 in a usable area where the microlenses 21 are formed with respect to the entire usable area can be approximated by the ratio of the length of the line segment L₃ (μm) to the length of the line segment L₄ (μm) (that is, L₃/L₄×100 (%)) (see FIG. 2).

In this regard, a region in which convex portions corresponding to the second concave portions 62 of the member 6 with concave portions (will be described later in detail) are formed is generally provided outside the usable lens region in which the microlenses 21 as described above are formed. Such convex portions (convex portions corresponding to the second concave portions 62) may be removed by means of a method such as grinding and polishing after obtaining the main substrate 2 by means of a manufacturing method as will be described later. Alternatively, the region in which the convex portions corresponding to the second concave portions 62 are formed may be removed by cutting it off. In other words, the microlens substrate 1 may not be provided with the convex portions corresponding to the second concave portions 62.

Further, as described above, the colored portion 22 is provided on the light incident surface of the microlens substrate 1 (that is, on the light incident side of each of the microlenses 21). The light entering the microlens substrate 1 from the light incident surface thereof can penetrate such a colored portion 22 efficiently, and the colored portion 22 has a function of preventing outside light from being reflected to the light emission side of the microlens substrate 1. By providing such a colored portion 22, it is possible to obtain a projected image having excellent contrast.

In particular, in the invention, the colored portion 22 is one that is formed by supplying a coloring liquid (particularly, a coloring liquid having a special feature of composition) onto the main substrate 2. (will be described later) To explain this special feature in detail, the colored portion 22 is one that is formed by supplying a coloring liquid (will be described later) onto the main substrate 2 so that a coloring agent in the coloring liquid impregnates the inside of the main substrate 2 (microlenses 21). In the case where the colored portion 22 is formed in this way, it is possible to heighten adhesion of the colored portion 22 compared with the case where the colored portion 22 is laminated on the one major surface of the main substrate 2. As a result, for example, it is possible to prevent a harmful influence due to change in the index of refraction in the vicinity of the interface between the colored portion 22 and the main substrate 2 on the optical characteristics of the microlens substrate from being generated more surely.

Further, since the colored portion 22 is formed by supplying the coloring liquid onto the main substrate 2, it is possible to reduce variation in the thickness of the respective portions (in particular, the variation in the thickness that does not correspond to the surface shape of the main substrate 2). This makes it possible to prevent disadvantage such as color heterogeneity from being generated in the projected image. Moreover, although the colored portion 22 is constituted from a material containing a coloring agent, the main component thereof is generally the same as the main component of the main substrate 2 (microlens substrate 1). Therefore, a rapid change in the index of refraction or the like is hardly generated in the vicinity of the boundary between the colored portion 22 and the other non-colored portion. As a result, it is easy to design the optical characteristics of the microlens substrate 1 as a whole, and it is possible to stabilize the optical characteristics of the microlens substrate 1 and to heighten the reliability thereof.

The color density of the colored layer 22 is not particularly limited. It is preferable that the color density of the colored layer 22 indicated by Y value (D65/2° angle of view) on the basis of spectral transmittance is in the range of 20 to 85%. More preferably it is in the range of 35 to 70%. In the case where the concentration of the coloring agent in the colored portion 22 is restricted within the above ranges, it is possible to improve the contrast of the image formed by the light penetrating the microlens substrate 1 particularly. On the other hand, in the case where the color density of the colored portion 22 is below the lower limit given above, the light transmission of the incident light is lowered and the obtained image cannot have sufficient brightness. As a result, there is a possibility that the contrast of the image becomes insufficient. Further, in the case where the color density of the colored portion 22 is over the upper limit given above, it is difficult to prevent the outside light (that is, outside light entering the microlens substrate 1 from the side opposite to the light incident side) from being reflected sufficiently, and since the increasing amount of front side luminance of black indication (black luminance) becomes large when a light source is fully turned off at a bright room, there is a possibility that the effect to improve the contrast of the projected image cannot be obtained sufficiently.

The color of the colored portion 22 is not particularly limited. It is preferable that the color of the colored portion 22 is an achromatic color, particularly black as appearance using a coloring agent in which the color thereof is based on blue and red, brown or yellow is mixed therein. Further, it is preferable that light having specific wavelengths for controlling balance of light's three primary colors (RGB) of a light source is selectively absorbed in the colored portion 22 or penetrates the colored portion 22. This makes it possible to prevent the outside light from being reflected. The tone of color of the image formed from the light penetrating the microlens substrate 1 can be expressed exactly, and chromatic coordinate is widened (the width of expression of the tone of color is made to widen sufficiently), and therefore a darker black can be expressed. As a result, it is possible to improve the contrast of the image, in particular.

Moreover, the black matrix 3 is provided on the light emission surface of the microlens substrate 1. In this case, the black matrix 3 is constituted from a material having a light shielding effect and formed in a laminated manner. By providing such a black matrix 3, it is possible to absorb outside light (which is not preferable to from a projected image) in the black matrix 3, and therefore it is possible to improve the image projected on a screen which has excellent contrast. In particular, by providing both the colored portion 22 as described above and the black matrix 3, it is possible to enhance the contrast of the image projected by the microlens substrate 1. Such a black matrix 3 is provided with a plurality of openings 31 on light path of the light penetrating each of the microlenses 21. Thus, the light condensed by each of the microlenses 21 can pass through the openings 31 of the black matrix 3 efficiently. As a result, it is possible to heighten the light use efficiency of the microlens substrate 1.

Further, it is preferable that the average thickness of the black matrix 3 is in the range of 0.01 to 5 μm. More preferably it is in the range of 0.01 to 3 μm, and further more preferably it is in the range of 0.03 to 1 μm. In the case where the average thickness of the black matrix 3 is restricted within the above ranges, it is possible to fulfill the function of the black matrix 3 more efficiently while preventing involuntary disadvantage such as separation and crack of the black matrix 3 more surely. For example, it is possible to improve the contrast of the image projected to a screen of a transmission screen 10 provided with the microlens substrate 1.

Next, a transmission screen 10 provided with the microlens substrate 1 as described above will now be described.

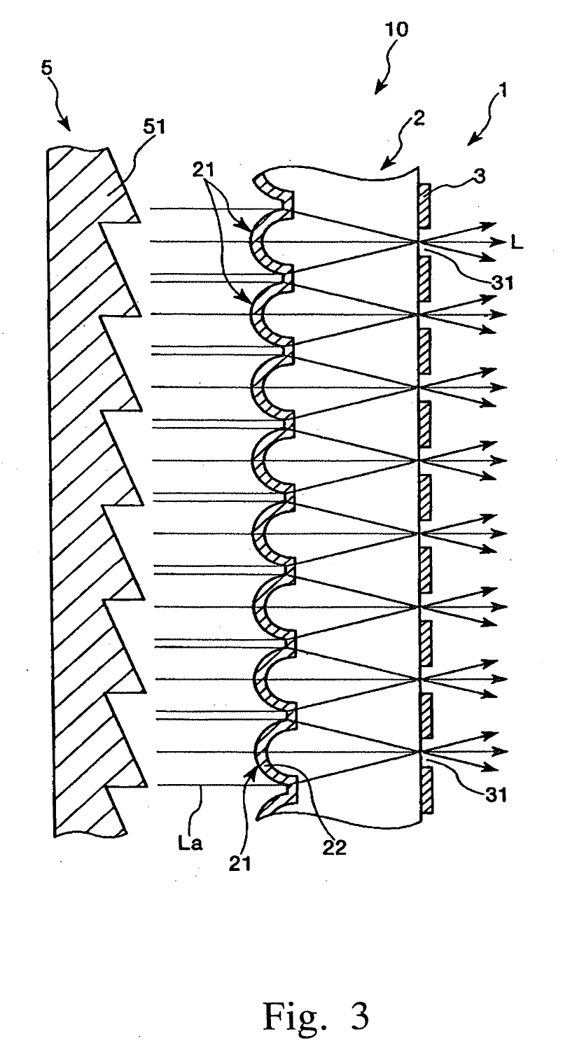

FIG. 3 is a longitudinal cross-sectional view which schematically shows a transmission screen 10 provided with the microlens substrate 1 shown in FIG. 1 in a preferred embodiment according to the invention. As shown in FIG. 3, the transmission screen 10 is provided with a Fresnel lens 5 and the microlens substrate 1 described above. The Fresnel lens 5 is arranged on the side of the light incident surface of the microlens substrate 1 (that is, on the incident side of light for an image), and the transmission screen 10 is constructed so that the light that has been transmitted by the Fresnel lens 5 enters the microlens substrate 1.

The Fresnel lens 5 is provided with a plurality of prisms that are formed on a light emission surface of the Fresnel lens 5 in a substantially concentric manner. The Fresnel lens 5 deflects the light for a projected image from a projection lens (not shown in the drawings), and outputs parallel light La that is parallel to the perpendicular direction of the major surface of the microlens substrate 1 to the side of the light incident surface of the microlens substrate 1.

In the transmission screen 10 constructed as described above, the light from the projection lens is deflected by the Fresnel lens 5 to become the parallel light La. Then, the parallel light La enters the microlens substrate 1 from the light incident surface on which the plurality of microlenses 21 are formed to be condensed by each of the microlenses 21 of the microlens substrate 1, and the condensed light then is focused and passes through the openings 31 of the black matrix (light shielding layer) 3. At this time, the light entering the microlens substrate 1 penetrates through the microlens substrate 1 with sufficient transmittance and the light penetrating the openings 31 is then diffused, whereby an observer (viewer) of the transmission screen 10 observes (watches) the as a flat image.

Next, a description will now be given for a substrate with concave portions (for manufacturing a microlens substrate) and a method of manufacturing the same according to the invention which can be used suitably to manufacture the microlens substrate (member with convex portions) 1 as described above.

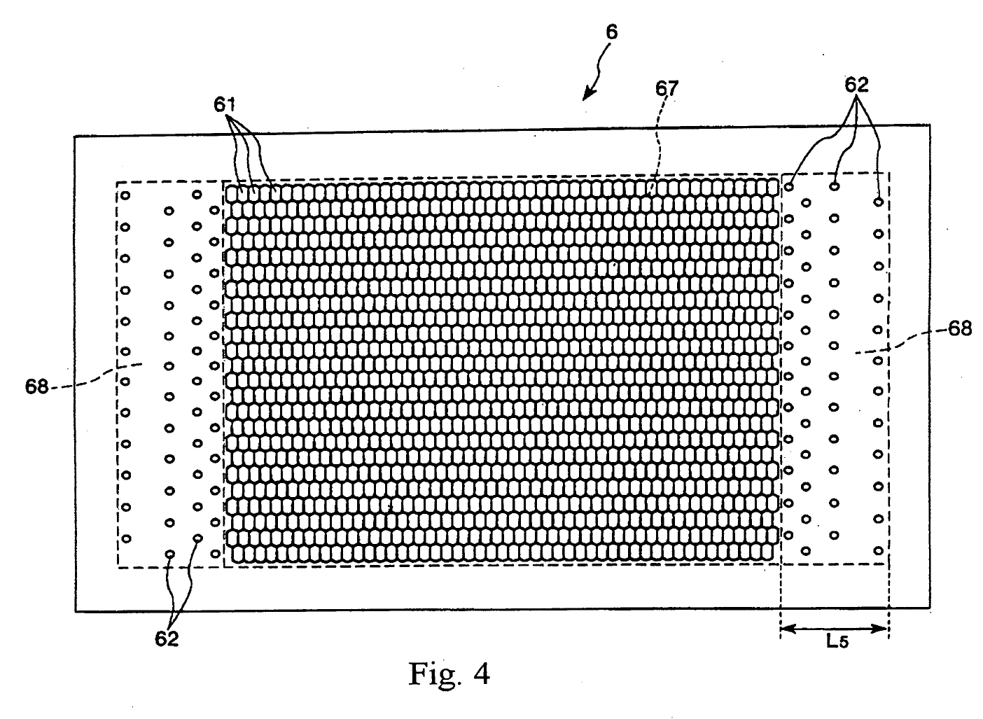

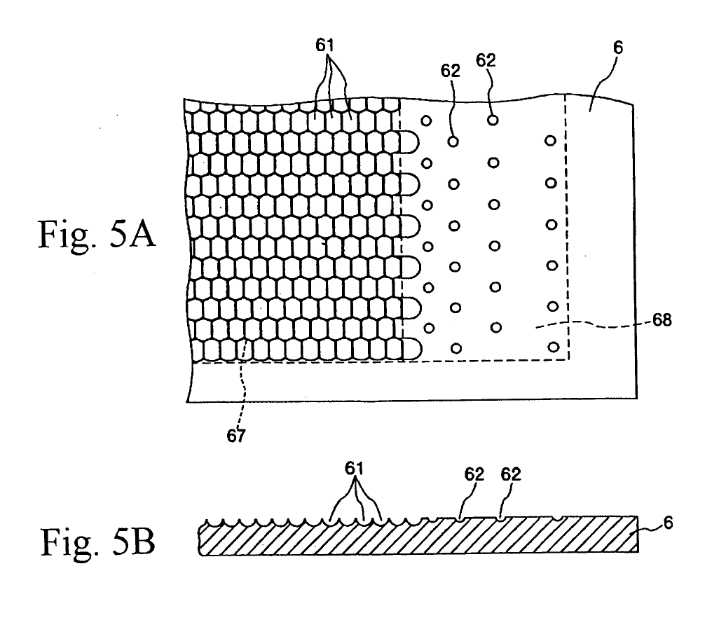

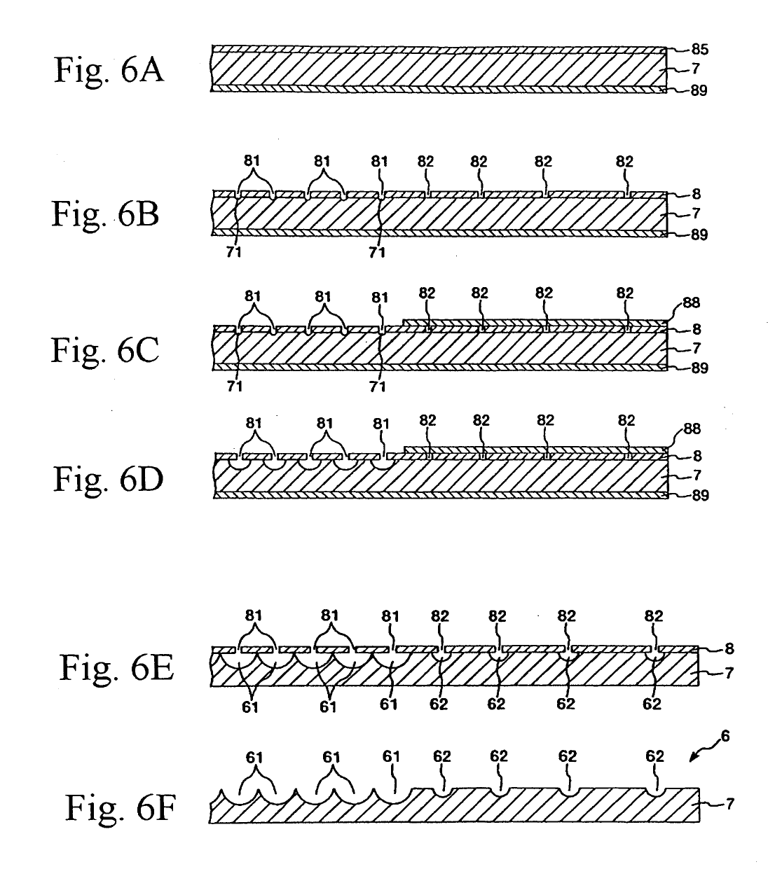

FIG. 4 is a plan view which schematically shows a member 6 with concave portions in an embodiment of the invention. FIGS. 5A and 5B are a partially enlarged view and a longitudinal cross-sectional view of the member 6 with concave portions shown in FIG. 4, respectively. FIG. 6 is a longitudinal cross-sectional view which schematically shows a method of manufacturing the member 6 with concave portions shown in FIGS. 4 and 5. In this regard, although a plurality of concave portions for forming microlenses 21 are actually formed on one major surface of the base member 7 in manufacturing the member 6 provided with a plurality of concave portions 61 for manufacturing a microlens substrate 1, and a plurality of convex portions are actually formed on the one surface of the main substrate 2 in manufacturing the microlens substrate 1, in order to make the explanation understandable, a part of the member 6 with concave portions is shown so as to be emphasized in FIGS. 4 to 6.

The configuration of the member 6 with concave portions (for manufacturing a microlens substrate) which can be used for manufacturing a microlens substrate (member with convex portions) 1 will first be described.

The member 6 with concave portions for manufacturing a microlens substrate 1 may be formed of any material such as various metal materials, various glass materials, and various resin materials, for example. In the case where the member 6 with concave portions is formed of any material having excellent stability of a shape thereof, it is possible to particularly improve the stability (reliability) of the shape of each of a plurality of first concave portions 61, and it is possible to improve accuracy of dimension of each of the microlenses 21 to be formed using the plurality of first concave portions 61 of the member 6 with concave portions, in particular. Further, it is also possible to heighten the reliability of the optical characteristics of the microlens substrate 1 as a lens substrate. As for such a material having excellent stability of the shape of each of the first concave portions 61, various metal materials, various glass materials and the like may be mentioned, for example.

Further, in the case where the member 6 with concave portions is formed of a material having transparency, it is possible to form a black matrix 3 on one major surface of the main substrate 2 while the member 6 with concave portions is in close contact with the main substrate 2 (that is, without removing the member 6 with concave portions from the main substrate 2) in the method of manufacturing a microlens substrate 1. This makes it possible to improve handleability of the main substrate 2 and to form the black matrix 3 thereon appropriately. As for such a material having transparency, various resin materials, various glass material and the like may be mentioned, for example.

The member 6 with concave portions for manufacturing a microlens substrate 1 has a shape in which the first concave portions 61 correspond to the microlenses (convex portions) 21 constituting the microlens substrate (member with convex portions) 1, and is provided with a plurality of first concave portions 61 for forming microlenses 21 which are arranged in a manner corresponding to the arrangement pattern of the microlenses 21 of the microlens substrate 1. Each of the first concave portions 61 generally has substantially the same size of each of the microlenses 21 (the same except that each of the microlenses 21 is a convex portion, while each of the first concave portions 61 is a concave portion, and that one has the mirror image relation with respect to the other), and the first concave portions 61 have the same arrangement pattern as the microlenses 21.

To explain it in detail, each of the first concave portions 61 (for forming microlenses 21) has a flat shape (in this case, such a shape includes a substantially elliptic shape, a substantial bale shape, and a shape in which the top and bottom portions of a substantially circular shape are cut) in which the perpendicular length is larger than the lateral width (that is, the length thereof in a long axis direction is larger than the length thereof in a short axis direction) when viewed from above the one major surface of the member 6 with concave portions for manufacturing a microlens substrate 1. In the case where each of the first concave portions 61 has such a shape, it is possible to prevent defects such as crack from being generated in the member 6 with concave portions and/or the microlenses 21 to be formed in the microlens substrate 1 more efficiently when releasing the member with convex portions (main substrate 2) from the member 6 with concave portions in manufacturing the microlens substrate 1 (that is, main substrate 2) as the member with convex portions. Further, it is possible to appropriately utilize the manufacture of the microlens substrate 1 which can improve the angle of view characteristics particularly while preventing disadvantage such as moire from being generated efficiently.

Further, in the case where the length (or pitch) of each of the first concave portions 61 in a short axis (or minor axis) direction thereof is defined as L₁ (μm) and the length (or pitch) of each of the first concave portions 61 in a long axis (or major axis) direction thereof is defined as L₂ (μm) when viewed from above the one major surface of the substrate 6 with concave portions, it is preferable that the ratio of L₁/L₂ is in the range of 0.10 to 0.99 (that is, L₁ and L₂ satisfy the relation: 0.10≦L₁/L₂≦0.99). More preferably it is in the range of 0.50 to 0.95, and further more preferably it is in the range of 0.60 to 0.80. By restricting the ratio of L₁/L₂ within the above range, the effect described above can become apparent.

Moreover, it is preferable that the length (or pitch) L₁ of each of the first concave portions 61 in the minor axis direction thereof when viewed from above the one major surface of the member 6 with concave portions is in the range of 10 to 500 μm. More preferably it is in the range of 30 to 300 μm, and further more preferably it is in the range of 50 to 100 μm. In the case where the length L₁ of each of the first concave portions 61 in the minor axis direction thereof is restricted within the above ranges, it is possible to obtain sufficient resolution in the image projected on the transmission screen 10 and further enhance the productivity of the microlens substrate 1 (and the member 6 with concave portions) while preventing disadvantage such as moire from being generated efficiently.

Furthermore, it is preferable that the length (or pitch) L₂ of each of the first concave portions 61 in the major axis direction thereof when viewed from above the one major surface of the member 6 with concave portions is in the range of 15 to 700 μm. More preferably it is in the range of 40 to 400 μm, and further more preferably it is in the range of 70 to 150 μm. In the case where the length L₂ of each of the first concave portions 61 in the major axis direction thereof is restricted within the above ranges, it is possible to obtain sufficient resolution in the image projected on the transmission screen 10 and further enhance the productivity of the microlens substrate 1 (and the member 6 with concave portions) while preventing disadvantage such as moiré from being generated efficiently.

Further, it is preferable that the radius of curvature of each of the first concave portions 61 in the minor axis direction thereof (hereinafter, referred to simply as “radius of curvature of the first concave portion 61” is in the range of 5 to 150 μm. More preferably it is in the range of 15 to 150 μm, and further more preferably it is in the range of 25 to 50 μm. By restricting the radius of curvature of each of the first concave portions 61 within the above range, it is possible to improve the angle of view characteristics of the transmission screen 10 provided with the microlens substrate 1. In particular, in this case, it is possible to improve the angle of view characteristics in both the horizontal and vertical directions of the transmission screen 10 provided with the microlens substrate 1.

Moreover, it is preferable that the depth of each of the first concave portions 61 is in the range of 8 to 500 μm. More preferably it is in the range of 15 to 150 μm, and further more preferably it is in the range of 25 to 50 μm. In the case where the depth of each of the first concave portions 61 is restricted within the above ranges, it is possible to prevent defects such as crack from being generated in the member 6 with concave portions and/or the microlenses 21 to be formed in the microlens substrate 1 more efficiently when releasing the member with convex portions (main substrate 2) from the member 6 with concave portions in manufacturing the microlens substrate 1 (that is, main substrate 2) as the member with convex portions. Further, it is possible to improve the angle of view characteristics of the transmission screen provided with the microlens substrate 1 to be manufactured.

Furthermore, in the case where the depth of each of the first concave portions 61 is defined as D₁ (μm) and the length of each of the first concave portions 61 in a short axis direction thereof is defined as L₁ (μm), it is preferable that D and L₁ satisfy the relation: 0.20≦L₁/D₁≦2.40. More preferably D and L₁ satisfy the relation: 0.5≦L₁/D₁≦1.9, and further more preferably D and L₁ satisfy the relation: 0.9≦L₁/D₁≦1.4. In the case where D and L₁ satisfy such relation as described above, it is possible to improve the angle of view characteristics of the microlens substrate 1 to be manufactured particularly while preventing moire due to interfere of light from being generated effectively.

Further, although the density of the first concave portions 61 in the first region 67 in which the first concave portions 61 are formed (that is, a region corresponding to the usable lens region of the microlens substrate 1) is not particularly limited, it is preferable that the density of the first concave portions 61 in the first region 67 is in the range of 1,000 to 500,000 pieces/cm². More preferably it is in the range of 5,000 to 200,000 pieces/cm², and further more preferably it is in the range of 10,000 to 100,000 pieces/cm². In the case where the density of the first concave portions 61 is restricted within the above ranges, it is possible to obtain an image having sufficiently high resolution to be projected in a transmission screen 10 provided with the microlens substrate 1 to be manufactured using the member 6 with concave portions. Further, in a method of manufacturing the microlens substrate 1 as will be described later, it is possible to prevent defects such as crack in the member 6 with concave portions and/or the microlenses 21 from being generated more effectively.

Further, the plurality of first concave portions 61 are arranged on the one major surface of the member 6 with concave portions in a houndstooth check manner. By arranging the plurality of first concave portions 61 in this way, it is possible to prevent disadvantage such as moire from being generated effectively. On the other hand, for example, in the case where the first concave portions 61 are arranged on the one major surface of the member 6 with concave portions in a square lattice manner or the like, it is difficult to prevent disadvantage such as moire from being generated sufficiently. Further, in the case where the first concave portions 61 are arranged on the one major surface of the member 6 with concave portions in a random manner, it is difficult to improve the share of the first concave portions 61 in a usable area (usable lens area) in which the first concave portions 61 are formed sufficiently, and it is difficult to improve light transmission into the microlens substrate and/or the member with concave portions (that is, light use efficiency) sufficiently. In addition, the obtained image becomes dark.

Moreover, although the first concave portions 61 are arranged on the member 6 with concave portions in a houndstooth check manner when viewed from above the one major surface of the member 6 with concave portions as described above, it is preferable that a first column of first concave portions 61 is shifted by a half pitch of each of the first concave portions 61 in a short axis direction thereof with respect to a second column of first concave portions 61 which is adjacent to the first column of first concave portions 61 when viewed from above the one major surface of the member 6 with concave portions. This makes it possible to prevent defects such as crack from being generated in the member 6 with concave portions and/or any microlenses 21 to be formed of the microlens substrate 1 more efficiently when releasing the member with convex portions (main substrate 2) from the member 6 with concave portions in manufacturing the microlens substrate 1 (main substrate 2) as the member with convex portions. Further, in the microlens substrate 1 to be manufactured, it is possible to improve the angle of view characteristics particularly while preventing moire due to interfere of light from being generated effectively.

Now, in the case of manufacturing a member with convex portions which has a large number of convex portions (convex lenses) corresponding to a large number of concave portions of a member with concave portions using the member with concave portions, there is a problem that it is difficult to release the member with convex portions from the member with concave portions. It is thought that this is because a minute pattern formed on the surface of the substrate with concave portions becomes a state where it clings to a lens substrate to be manufactured due to the anchor effect. Further, when the member with concave portions is forcedly removed from the member with convex portions thus manufactured, there is a problem that defects such as crack of the member with concave portions and/or the convex portions (convex lenses) formed by the transfer of the shape of the concave portions are generated. Thus, for the reason described above, there is also a problem that yield of the member with convex portions is made to lower extremely. Accordingly, the inventor has persevered in keen examination in order to solve the problems as described above. As a result, the inventor found that, in the case of releasing the member with convex portions from the member with concave portions, stress to the member with concave portions and the member with convex portions becomes larger at the initial step of the release (more specifically, the step of proceeding the release of convex portions to be released from the corresponding concave portions at the initial step), and the stress is made to be lower once the release of the convex portions formed in the concave portions from the concave portions is proceeded. Further, the inventor found that, by providing concave portions (second concave portions) each of whose depth is shallower than the depth of each of the above-mentioned concave portions (first concave portions) outside the region (first region, or usable region) in which the concave portions (first concave portions) corresponding to the convex portions to be formed are formed, it is possible to prevent the defects from being generated in the member with concave portions and/or the convex portions to be formed. In particular, the inventor found that it is possible to prevent the problems as described above from being generated even in the case of using the member with concave portions repeatedly.

In the preset embodiment, the member 6 with concave portions (for manufacturing a microlens substrate) is provided with a plurality of second concave portions 62 outside the region (that is, first region 67 corresponding to the usable lens region of the microlens substrate 1) in which the first concave portions 61 are formed in addition to the first concave portions 61 as described above. More specifically, the second region (unusable region) 68 in which the second concave portions 62 are formed is provided at each side of both end sides of the first region 67 in which the first concave portions 61 are formed in the longitudinal direction thereof (one of the ends corresponds to the release start side of the main substrate (member with convex portions) 2 from the member 6 with concave portions.

By providing the second concave portions 62 (second region 68) at the release start side with respect to the first region 67 in which the first concave portions 61 are formed in this way, it is possible to absorb the stress to the member 6 with concave portions and/or the main substrate 2 to be formed into the formation region of the second concave portions 62 (that is, the second region 68 of the member with concave portions corresponding to the unusable lens region of the microlens substrate 1) when releasing the main substrate 2 from the member with concave portions. Thus, the stress when releasing is reduced in the formation region of the first concave portions 61 (that is, the first region 67) and the usable lens region of the microlens substrate 1, and therefore, it is possible to carry out the release with relatively small force stably. In addition, it is possible to prevent the defects from being generated in the concavo-convex pattern of the member 6 with concave portions and/or the main substrate 6 efficiently. As a result, it is possible to lengthen the lifetime of the member 6 with concave portions. Moreover, by using the member 6 with concave portions of the invention, it is possible to manufacture the microlens substrate 1 (main substrate 2) stably, and this makes it possible to improve the productivity of the microlens substrate 1. In the microlens substrate (member with convex portions) 1 of the invention to be manufactured using the member 6 with concave portions of the invention, it is possible to prevent disadvantage such as crack of the concavo-convex pattern from being generated efficiently, and the microlens substrate (member with convex portions) 1 of the invention has an excellent quality (in particular, optical characteristics). Furthermore, this makes it possible to improve the productivity of the microlens substrate 1.

Although the depth of each of the second concave portions 62 is not particularly limited as long as it is shallower than the depth of each of the first concave portions 61, it is preferable that the depth of each of the second concave portions 62 is in the range of 5 to 400 μm. More preferably it is in the range of 15 to 150 μm, and further more preferably it is in the range of 25 to 50 μm. In the case where the depth of each of the second concave portions 62 is restricted within the above ranges, it is possible to prevent defects such as crack from being generated in the member 6 with concave portions and/or the microlenses 21 to be formed in the microlens substrate 1 still more efficiently when releasing the member with convex portions (main substrate 2) from the member 6 with concave portions in manufacturing the microlens substrate 1 (that is, main substrate 2) as the member with convex portions.

Further, in the case where the depth of each of the plurality of first concave portions is defined as D₁ (μm) and the depth of each of the plurality of second concave portions is defined as D₂ (μm), it is preferable that D₁ and D₂ satisfy the relation: 3≦D₁−D₂≦495. More preferably D₁ and D₂ satisfy the relation: 5≦D₁−D₂≦200, and further more preferably D₁ and D₂ satisfy the relation: 10≦D₁−D₂≦50. In the case where D₁ and D₂ satisfy such relation as described above, it is possible to prevent defects such as crack from being generated in the member 6 with concave portions and/or the microlenses 21 to be formed in the microlens substrate 1 still more efficiently when releasing the member with convex portions (main substrate 2) from the member 6 with concave portions in manufacturing the microlens substrate 1 (that is, main substrate 2) as the member with convex portions.

Moreover, in the present embodiment, the size of each of the second concave portions 62 is smaller than the size of each of the first concave portions 61 when viewed from above one major surface of the member 6 with concave portions. In the case where the size of each of the second concave portions 62 is smaller than the size of each of the first concave portions 61 in this way, it is possible to absorb the stress to the member 6 with concave portions and/or the main substrate 2 in the vicinity of the second concave portions 62 efficiently, and it is possible to achieve the effects as described above further remarkably. Furthermore, in the case where the size of each of the second concave portions 62 is relatively small, it is possible to reduce the stress to the vicinity of the second concave portions 62. Therefore, it is possible to improve the stability of the shape of the member 6 with concave portions (in particular, the vicinity of the second concave portions 62) particularly. As a result, it is possible to improve the endurance of the member 6 with concave portions particularly. Furthermore, it is possible to improve the productivity of the microlens substrate 1.

Further, in the present embodiment, the density of the second concave portions 68 in the second region 68 (that is, formation region of the second concave portions 62), that is, the number of pieces of the second concave portions 62 per unit area when viewed from above one major surface of the member 6 with concave portions is lower than the density of the first concave portions 61 in the first region 67. By providing the second concave portions 62 (second region 68) in this way, it is possible to achieve the effect as described above more remarkably, and it is possible to improve the stability of the shape of each of the second concave portions 62. Thus, it is possible to improve the endurance of the member 6 with concave portions, and this makes it possible to improve yield of the microlens substrate 1.

Although the density of the second concave portions 62 in the second region 68 in which the second concave portions 62 are formed is not particularly limited, it is preferable that the density of the second concave portions 62 in the second region 68 is in the range of 1,000 to 500,000 pieces/cm². More preferably it is in the range of 5,000 to 200,000 pieces/cm², and further more preferably it is in the range of 10,000 to 100,000 pieces/cm². In the case where the density of the second concave portions 62 is restricted within the above ranges, it is possible to achieve the effects as described above still more remarkably. Thus, it is possible to improve the stability of the shape of each of the second convex portions 62, and it is possible to improve the endurance of the member 6 with concave portions particularly.

Further, in the case where the density of the first concave portions 61 in the first region 67 is defined as d₁ (pieces/cm²) and the density of the second concave portions 62 in the second region 68 is defined as d₂ (pieces/cm²), then it is preferable that d₁ and d₂ satisfy the relation: 0.001≦d₁/d₂≦0.999. More preferably d₁ and d₂ satisfy the relation: 0.01≦d₁/d₂≦0.90, and further more preferably d₁ and d₂ satisfy the relation: 0.05≦d₁/d₂≦0.80. Most preferably d₁ and d₂ satisfy the relation: 0.1≦d₁/d₂≦0.68. In the case where d₁ and d₂ satisfy such relation, it is possible to achieve the effects as described above still more remarkably. Thus, it is possible to improve the stability of the shape of each of the second convex portions 62, and it is possible to improve the endurance of the member 6 with concave portions particularly.

Moreover, in the present embodiment, the second concave portions 62 are arranged so that the density of the second concave portions 62 become rarefactive gradually from the side in which the first concave portions 61 are formed (that is, the side of the first region 67) toward the end portion of the member 6 with concave portions. This makes it possible to achieve the effects as described above still more remarkably. Thus, it is possible to improve the stability of the shape of each of the second convex portions 62, and it is possible to improve the endurance of the member 6 with concave portions particularly.

The shape of each of the second concave portions 62 (the shape thereof when viewed from above one major surface of the member 6 with concave portions) is not particularly limited. For example, as for such a shape, a circular shape, a flat shape (including an elliptic shape) in which the perpendicular length of each of the second concave portions 62 is longer than the horizontal length thereof, a flat shape in which the horizontal length of each of the second concave portions 62 is longer than the perpendicular length thereof, a flat shape in which one of the perpendicular and horizontal lengths thereof is randomly longer than the other, and the like may be mentioned.

Further, the number of the second concave portions 68 in the second region 68 is not particularly limited. In the case where the second concave portions 62 are provided in the second region 68 in a linear manner (that is, linearly in a direction substantially perpendicular to the release direction), it is preferable that the number of the arrays of the second concave portions 62 thus provided is in the range of about 10 to 50,000. More preferably it is in the range of about 500 to 10,000, and further more preferably it is in the range of about 2,000 to 5,000. This makes it possible to achieve the effects as described above sufficiently and remarkably while preventing the unusable lens region of the microlens substrate 1 from being enlarged more than necessary. In addition, it is possible to improve the stability of the shape of each of the second convex portions 62, and it is possible to improve the endurance of the member 6 with concave portions particularly.

Moreover, in the case where the second concave portions 62 are provided in the second region 68 in a linear manner (that is, linearly in a direction substantially perpendicular to the release direction), the average pitch of two adjacent arrays of the second concave portions 62 is not particularly limited. For example, it is preferable that the average pitch of two adjacent arrays is in the range of 20 to 1,000 μm. More preferably it is in the range of 30 to 700 μm, and further more preferably it is in the range of 50 to 500 μm. In the case where the average pitch of two adjacent arrays is restricted within the above ranges, it is possible to achieve the effects as described above still more remarkably. Thus, it is possible to improve the stability of the shape of each of the second convex portions 62, and it is possible to improve the endurance of the member 6 with concave portions particularly.

The length of the second region 68 in the release direction thereof (that is, the length indicated by L₅ in FIG. 4) is not particularly limited. For example, it is preferable that the length of the second region 68 in the release direction thereof is in the range of 20 to 500 μm. More preferably it is in the range of 30 to 350 μm, and further more preferably it is in the range of 50 to 200 μm. In the case where the length of the second region 68 in the release direction thereof is restricted within the above ranges, it is possible to achieve the effects as described above sufficiently and remarkably while preventing the unusable lens region of the microlens substrate 1 from being enlarged more than necessary. In addition, it is possible to improve the endurance of the member 6 with concave portions particularly.

As described above, when the microlens substrate (member with convex portions) 1 is released from the member with concave portions (for manufacturing a microlens substrate), the stress to both the members is absorbed in the vicinity of the second concave portions 62 (that is, second region 68). For this reason, it is possible to prevent the concavo-convex pattern of the formation region of the microlenses from being destroyed. Therefore, the member 6 with concave portions has a long lifetime and excellent handleability.

Further, by using the member 6 with concave portions as a mold, it is possible to prevent crash (breaking) of the concave portions or the convex portions or variation thereof from being generated efficiently, and it is possible to transfer the surface shape of the member with concave portions to the microlens substrate 1 truly. Thus, it is possible to obtain the microlens substrate (member with convex portions) 1 having excellent optical characteristics. Moreover, it is possible to display an image having a high quality to be projected in the transmission screen 10 and the rear projection 300 provided with such a microlens substrate (member with convex portions) 1 stably.

In this regard, in the above explanation, it has been described that each of the first concave portions 61 has substantially the same shape (size) as that of each of the microlenses (convex portions) 21 with which the microlens substrate (member with convex portions) 1 is provided, and the first concave portions 61 have substantially the same arrangement pattern as that of the microlenses 21. However, for example, in the case where the constituent material of the main substrate 2 of the microlens substrate (member with convex portions) 1 tends to contract easily (that is, in the case where the resin material constituting the main substrate 2 is contracted by means of solidification or the like), the shape (and size), share or the like with respect to each of the microlenses (convex portions) 21 with which the microlens substrate 1 is provided and the first concave portions 61 with which the member 6 with concave portions (for manufacturing a microlens substrate 1) is provided may be different from each other in view of the percentage of contraction or the like. Further, in this case, although it is easy to generate disadvantage such as crack in the member with concave portions and/or the microlens substrate in the conventional method (that is, in the method using a conventional substrate with concave portions), in the invention, it is possible to prevent the disadvantage as described above from being generated efficiently even in such a case.

Next, the method of manufacturing the member 6 with concave portions according to the invention will now be described with reference to FIG. 6. In this regard, although a plurality of first concave portions 61 for forming microlenses 21 and a plurality of second concave portions 62 are actually formed in a base member 7, in order to make the explanation understandable, a part of the base member 7 is shown so as to be emphasized in FIG. 6.

First, a base member 7 is prepared in manufacturing the member 6 with concave portions.

It is preferable that a base material having a substantially column shape or substantially cylinder shape is used for the base member 7. Further, it is also preferable that a base material with a surface cleaned by washing or the like is used for the base member 7.

Although soda-lime glass, crystalline glass, quartz glass, lead glass, potassium glass, borosilicate glass, alkali-free glass and the like may be mentioned as for a constituent material for the base member 7, soda-lime glass and crystalline glass (for example, neoceram or the like) are preferable among them. By the use of soda-lime glass, crystalline glass or alkali-free glass, it is easy to process the material for the base member 7, and it is advantageous from the viewpoint of a manufacturing cost of the member 6 with concave portions because soda-lime glass or crystalline glass is relatively inexpensive.

<A1> As shown in FIG. 6A, a film 85 for forming a mask is formed on the surface of the prepared base member 7 (coating process). The film 85 for forming a mask functions as a mask by forming a plurality of openings (initial holes) at the subsequent process. Then, a back surface protective film 89 is formed on the back surface of the base member 7 (that is, the surface side opposite to the surface on which the film 85 for forming a mask is formed). Needless to say, the film 85 for forming a mask and the back surface protective film 89 may be formed simultaneously.

The constituent material of the film 85 for forming a mask (mask 8) is not particularly limited, for example, metals such as Cr, Au, Ni, Ti, Pt, and the like, metal alloys containing two or more kinds of metals selected from these metals, oxides of these metals (metal oxides), silicon, resins, and the like may be mentioned.

Further, the film 85 for forming a mask (mask 8) may be, for example, one having a substantially even composition, or a laminated structure by a plurality of layers.

As described above, the structure of the film 85 for forming a mask (mask 8) is not particularly limited, and it is preferable that the film 85 for forming a mask (mask 8) has a laminated structure constructed from a layer formed of chromium as a main material and a layer formed of chromium oxide as a main material. The film 85 for forming a mask (mask 8) having such a structure has excellent stability with respect to various etchants having various structures (that is, it is possible to protect the base member 7 more surely at an etching process (as will be described later)), and it is possible to form the openings (initial holes 81) each having a desired shape easily and surely by means of irradiation with laser beams or the like as will be described later. Further, in the case where the film 85 for forming a mask (mask 8) has such a structure as described above, a solution containing ammonium hydrogen difluoride (NH₄HF₂), for example, may be appropriately used as an etchant at the etching process (will be described later). Since a solution containing ammonium hydrogen difluoride is not poison, it is possible to prevent its influence on human bodies during work and on the environment more surely. Moreover, the film 85 for forming a mask (mask 8) having such a structure makes it possible to reduce internal stress of the film 85 for forming a mask (mask 8) effectively, and such a film 85 for forming a mask (mask 8) has excellent adhesion (that is, adhesion of the film 85 for forming a mask (mask 8) to the base member 7 at the etching process, in particular) to the base member 7, in particular. For these reasons, by using the film 85 for forming a mask (mask 8) having the structure described above, it is possible to form a plurality of first concave portions 61 each having a desired shape easily and surely.

The method of forming the film 85 for forming a mask (mask 8) is not particularly limited. In the case where the film 85 for forming a mask (mask 8) is constituted from any of metal materials (including metal alloys) such as Cr and Au or metal oxides such as chromium oxide, the film 85 for forming a mask (mask 8) can be suitably formed by means of an evaporation method, a sputtering method, or the like, for example. On the other hand, in the case where the film 85 for forming a mask (mask 8) is formed of silicon, the film 85 for forming a mask (mask 8) can be suitably formed by means of a sputtering method, a CVD method, or the like, for example.

Although the thickness of the film 85 for forming a mask (mask 8) also varies depending upon the material constituting the film 85 for forming a mask (mask 8), it is preferable that the thickness of the film 85 for forming a mask (mask 8) is in the range of 0.01 to 2.0 μm, and more preferably it is in the range of 0.03 to 0.2 μm. If the thickness of the film 85 for forming a mask (mask 8) is below the lower limit given above, there may be a possibility to deform the shapes of the initial holes (in particular, first initial holes 81) formed at the initial hole formation process (or openings formation process, which will be described later) depending upon the constituent material of the film 85 for forming a mask (mask 8) or the like. In addition, there is a possibility that sufficient protection for the masked portion of the base member 7 cannot be obtained during a wet etching process at the etching step (will be described later). On the other hand, if the thickness of the film 85 for forming a mask (mask 8) is over the upper limit given above, in addition to the difficulty in formation of the first initial holes 81 that penetrate the mask 8 at the initial hole formation process (or openings formation process), there will be a case in which the mask 8 tends to be easily removed due to internal stress thereof depending upon the constituent material or the like of the film 85 for forming a mask (mask 8).

The back surface protective film 89 is provided for protecting the back surface of the base member 7 at the subsequent processes. Erosion, deterioration or the like of the back surface of the base member 7 can be suitably prevented by means of the back surface protective film 89. Since the back surface protective film 89 has, for example, the same configuration as that of the film 85 for forming a mask, it may be provided in a manner similar to the formation of the film 85 for forming a mask simultaneously with the formation of the film 85 for forming a mask.

<A2> Next, as shown in FIG. 6B, a plurality of first initial holes 81 and a plurality of second initial holes 82 that will be utilized as mask openings at the etching process (described later) are formed in the film 85 for forming a mask (initial hole formation process). Thus, a mask 8 having a predetermined opening pattern is obtained. The method of forming the first initial holes 81 and the second initial holed 82 is not particularly limited, but it is preferable that the first initial holes 81 and the second initial holes 82 are formed by the irradiation with laser beams. This makes it possible to form the first initial holes 81 and the second initial holes 82 each having a desired shape, which are arranged in a desired pattern, easily and accurately. As a result, it is possible to control the shape of each of the first concave portions 61 and the second concave portions 62, the arrangement pattern thereof, or the like more surely. Further, by forming the first initial holes 81 and the second initial holes 82 by means of the irradiation with laser beams, it is possible to manufacture the member 6 with concave portions at high productivity. In particular, the concave portions can be easily formed on a relatively large-sized substrate. Moreover, in the case where the initial holes (including the first initial holes 81 and the second initial holes 82) are formed by means of irradiation with laser beams, by controlling the irradiation conditions thereof, it is possible to form only the initial holes (including the first initial holes 81 and the second initial holes 82) without forming initial concave portions (will be described later), or it is possible to form the initial concave portions (the first initial concave portions 71) in which variation in shape, size and depth thereof is made to be small easily and surely in addition to the initial holes (including the first initial holes 81 and the second initial holes 82). Furthermore, by forming the first initial holes 81 and the second initial holes 82 in the film 85 for forming a mask by means of irradiation with laser beams, it is possible to form the openings (the first initial holes 81 and the second initial holes 82) in the film 85 for forming a mask at a low cost easily compared with the case of forming openings in a mask by means of a conventional photolithography method.

Further, in the case where the first initial holes 81 and the second initial holes 82 are formed by means of the irradiation with laser beams, the kind of laser beam to be used is not particularly limited, but a ruby laser, a semiconductor laser, a YAG laser, a femtosecond laser, a glass laser, a YVO₄ laser, a Ne—He laser, an Ar laser, a carbon dioxide laser, an excimer laser or the like may be mentioned. Moreover, a waveform of a laser such as SHG (second-harmonic generation), THG (third-harmonic generation), FHG (fourth-harmonic generation) or the like may be utilized.

When the first initial holes 81 and the second initial holes 82 are formed in the film 85 for forming a mask, as shown in FIG. 6B, the first initial concave portions 71 may also be formed in the base member 7 by removing parts of the surface of the base member 7 in addition to the first initial holes 81 and the second initial holes 82. This makes it possible to increase contact area of the base member 7 with the etchant when subjecting the base member 7 with the mask 8 to the etching process (will be described later), whereby erosion can be started suitably. Further, by adjusting the depth of each of the first initial concave portions 71, it is also possible to adjust the depth of each of the first concave portions 61 and the second concave portions (that is, the maximum thickness of the lens (microlens 21)). In particular, in the present embodiment, as shown in FIG. 6, the initial concave portions 71 are formed only at the portions corresponding to the first concave portions 61 (that is, the first initial holes 81), while no initial concave portions are formed at the portions corresponding to the second concave portions 62 (that is, the second initial holes 82). Thus, it is possible to make the difference of the depth of each of the first concave portions 61 and the depth of each of the second concave portions 62 to become relatively large easily and surely. By controlling the irradiation conditions of the laser beams, it is possible to manage formation or non-formation of such initial concave portions easily and surely.

Although the depth of each of the first initial concave portions 71 is not particularly limited, it is preferable that it is 5.0 μm or less, and more preferably it is in the range of about 0.1 to 0.5 μm. In the case where the formation of the first initial holes 81 and the second initial holes 82 is carried out by means of the irradiation with laser beams, it is possible to surely reduce variation in the depth of each of the first initial concave portions 71 formed together with the first initial holes 81 and the second initial holes 82. This makes it possible to reduce variation in the depth of each of the first concave portions 61 constituting a member 6 with concave portions, and therefore it is possible to reduce variation in the size and shape of each of the microlenses 21 in the microlens substrate 1 obtained finally. As a result, it is possible to reduce variation in the diameter, the focal distance, and the thickness of the lens of each of the microlenses 21, in particular.

The shape and size of each of the first initial holes 81 to be formed at the present process is not particularly limited. In the case where each of the first initial holes 81 is a substantially circular shape, it is preferable that the diameter of each of the first initial holes 81 is in the range of 0.8 to 20 μm. More preferably it is in the range of 1.0 to 10 μm, and further more preferably it is in the range of 1.5 to 4 μm. In the case where the diameter of each of the first initial holes 81 is restricted within the above ranges, it is possible to form the first concave portions 61 each having the shape as described above at an etching process (will be described later) surely. On the other hand, in the case where each of the first initial holes 81 is a flat shape such as a substantially elliptic shape, it is possible to substitute the length thereof in the short axis direction (that is, width thereof) for the diameter thereof. Namely, in the case where each of the first initial holes 81 to be formed at the present process is the substantially elliptic shape, the width of each of the first initial holes 81 (the length in the short axis direction thereof) is not particularly limited, but the width of each of the first initial holes 81 is in the range of 0.8 to 20 μm. More preferably it is in the range of 1.0 to 10 μm, and further more preferably it is in the range of 1.5 to 4 μm. In the case where the width of each of the first initial holes 81 is restricted within the above ranges, it is possible to form the first concave portions 61 each having the shape as described above at an etching process (will be described later) surely.

Further, in the case where each of the first initial holes 81 to be formed at the present process is the substantially elliptic shape, the length of each of the first initial holes 81 (the length in the long axis direction thereof) is not particularly limited, but the width of each of the first initial holes 81 is in the range of 0.9 to 50 μm. More preferably it is in the range of 1.5 to 20 μm, and further more preferably it is in the range of 2.0 to 15 μm. In the case where the width of each of the first initial holes 81 is restricted within the above ranges, it is possible to form the first concave portions 61 each having the shape as described above at an etching process (will be described later) more surely.

Further, other than by means of the irradiation with laser beams, the first initial holes 81 and the second initial holes 82 may be formed in the coated film 85 for forming a mask by, for example, previously arranging foreign objects on the base member 7 with a predetermined pattern when the film for forming a mask is coated on the base member 7, and then coating the film 85 for forming a mask on the base member 7 with the foreign objects to form defects in the mask 8 by design so that the defects are utilized as the first initial holes 81 and the second initial holes 82.

In this regard, in the configuration as shown in FIG. 6, even though it has been described that the initial concave portions are formed only at the portions corresponding to the first concave portions 61 (that is, the first initial holes 81), initial concave portions may also be formed at the portions corresponding to the second concave portions 62 (that is, the second initial holes 82). In this case, the depth, the shape and the like of each of the first initial concave portions 71 corresponding to the first concave portions 61 (that is, the first initial holes 81) may be different from those of each of the second initial concave portions corresponding to the second concave portions 62 (that is, the second initial holes 82). For example, the depth of each of the second initial concave portions corresponding to the second concave portions 62 may be shallower than the depth of each of the first initial concave portions 71 corresponding to the first concave portions 61.

<A3> Next, as shown in FIG. 6C, a sealing member (tape) 88 having resistance to etching is applied to the region (corresponding to the second region in which the second initial holes 82 are formed in the mask 8.

<A4> Next, the base member 7 is subjected to an etching process (etching process). The etching process is not particularly limited, and for example, a wet etching process, a dry etching process and the like may be mentioned. In the following explanation, the case of using the wet etching process will be described as an example.

First, the base member 7 coated with the mask 8 (having the first initial holes 81 and the second initial holes 82) and the sealing member 88 is subjected to an etching process (in this case, a wet etching process). Thus, as shown in FIG. 6D, the etching proceeds at the portions of the base member 7 corresponding to the first initial holes 81 of the mask 8, while such etching does not proceed at the portion in which the mask 8 is coated with the sealing member 88.

The sealing member 88 is then removed in process of the etching process. Thus, the etching also starts at the portion in which the mask 8 has been coated with the sealing member 88, and as shown in FIG. 6E, the first concave portions 61 and the second concave portions 62 each having a predetermined depth shallower than the depth of each of the first concave portions 61 are formed in the base member 7.

As mentioned above, in the present embodiment, since the first initial holes 81 formed in the mask 8 are arranged in a houndstooth check manner, the first concave portions 61 to be formed are also arranged on the surface of the base member 7 in a houndstooth check manner. Further, the second initial concave portions 82 formed in the mask 8 has lower density than that of the first initial concave portions 81, and the second initial concave portions 82 are arranged so as to become rarefactive gradually toward the outside of the base member 7 with the mask 8. For this reason, the second concave portions 62 to be formed has lower density than that of the first concave portions 61, and the second concave portions 62 are arranged so as to become rarefactive gradually toward the outside of the base member 7.

Further, in the present embodiment, the first initial concave portions 71 are formed on the surface of the base member 7 when the first initial holes 81 and the second initial holes 82 are formed in the film 85 for forming a mask at step <A2>. This makes the contact area of the base member 7 with the etchant increase during the etching process, whereby erosion can be made to start suitably. Moreover, the first concave portions 61 and second concave portions 62 can be formed suitably by employing the wet etching process. In the case where an etchant containing, for example, ammonium hydrogen difluoride is utilized for an etchant, the base member 7 can be eroded more selectively, and this makes it possible to form the first concave portions 61 and the second concave portions 62 suitably.

In the case where the mask 8 is mainly constituted from chromium (that is, the mask 8 is formed of a material containing Cr as a main material thereof), a solution of ammonium hydrogen difluoride is particularly suited as a hydrofluoric acid-based etchant. Since a solution containing ammonium hydrogen difluoride is not poison, it is possible to prevent its influence on human bodies during work and on the environment more surely. Further, in the case where the solution of ammonium hydrogen difluoride is used as an etchant, for example, hydrogen peroxide may be contained in the etchant. This makes it possible to accelerate the etching speed.

Further, the wet etching process can be carried out with simpler equipment than that in the dry etching process, and it allows the processing for a larger number of base members 7 at a time. This makes it possible to enhance productivity of the member 6 with concave portions, and it is possible to provide the member 6 with concave portions at a lower cost.

<A5> Next, the mask 8 is removed as shown in FIG. 6F (mask removal process). At this time, the back surface protective film 89 is also removed along with the mask 8. In the case where the mask 8 is constituted from the laminated structure constructed from the layer formed of chromium as a main material and the layer formed of chromium oxide as a main material as described above, the removal of the mask 8 can be carried out by means of an etching process using a mixture of ceric ammonium nitrate and perchloric acid, for example.

As a result of the processing in the above, as shown in FIGS. 6F, 4 and 5, a member 6 with concave portions in which a large number of first concave portions 61 are formed in the base member 7 in a houndstooth check manner and a large number of second concave portions 62 are formed outside the region where the first concave portions 61 are formed in a random manner is obtained.

The method of forming the plurality of first concave portions 61 and the plurality of second concave portions 62 on the surface of the base member 7 is not particularly limited. In the case where the first concave portions 61 and the second concave portions 62 are formed by means of the method as mentioned above, that is, the method of forming the first concave portions 61 and the second concave portions 62 in the base member 7 by forming the first initial holes 81 and the second initial holes 82 in the film 85 for forming a mask by means of the irradiation with laser beams to obtain the mask 8 on the base member 7 and then subjecting the base member 7 to the etching process using the mask 8, it is possible to obtain the following effects.

Namely, by forming the first initial holes 81 and the second initial holes 82 in the film 85 for forming a mask by means of the irradiation with laser beams to obtain the mask 8, it is possible to form openings (first initial holes 81 and second initial holes 82) in a predetermined pattern in the film 85 for forming a mask easily and inexpensively compared with the case of forming the openings in a film for forming a mask by means of the conventional photolithography method. This makes it possible to enhance productivity of the member 6 with concave portions, whereby it is possible to provide the member 6 with concave portions at a lower cost.

Further, according to the method as described above, it is possible to carry out the processing for a large-sized substrate easily. Also, according to the method, in the case of manufacturing such a large-sized substrate, there is no need to bond a plurality of substrates as the conventional method, whereby it is possible to eliminate the appearance of seams of bonding. This makes it possible to manufacture a high quality large-sized member 6 with concave portions for forming microlenses 21 (that is, microlens substrate 1) by means of a simple method at a low cost.

Further, in the case of forming the first initial holes 81 and the second initial holes 82 by means of the irradiation of laser beams, it is possible to control the shape and size of each of the first initial holes 81 and the second initial holes 82 to be formed, arrangement thereof, and the like easily and surely.

Moreover, by using the sealing member 88 at the etching process, it is possible to form the first concave portions 61 and the second concave portions 62 in which the depths of them are different from each other easily and surely. Furthermore, it is possible to control the depths of the first concave portions 61 and the second concave portions 62 to be formed easily and surely.

Next, a method of manufacturing the microlens substrate (member with convex portions) 1 using the member 6 with concave portions will now be described.

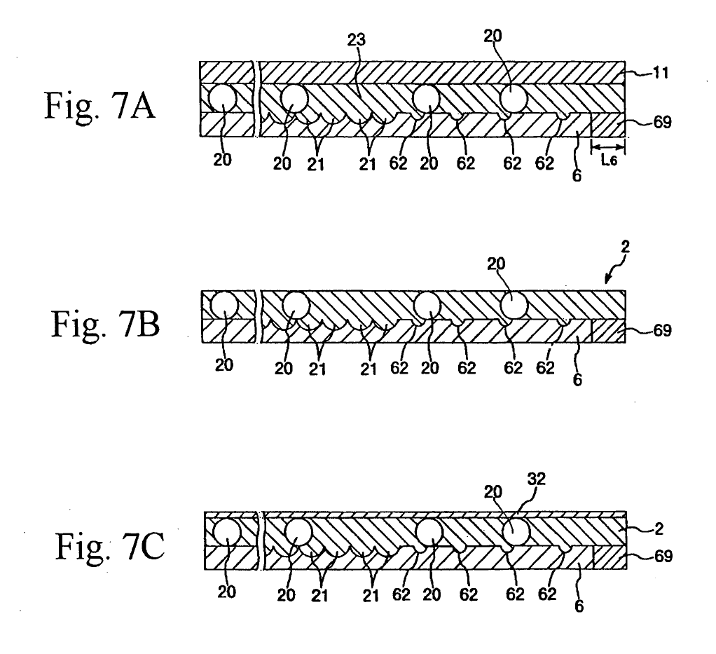

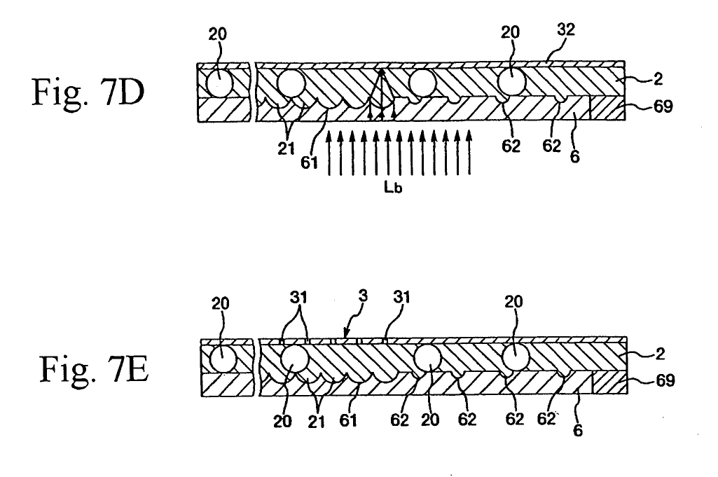

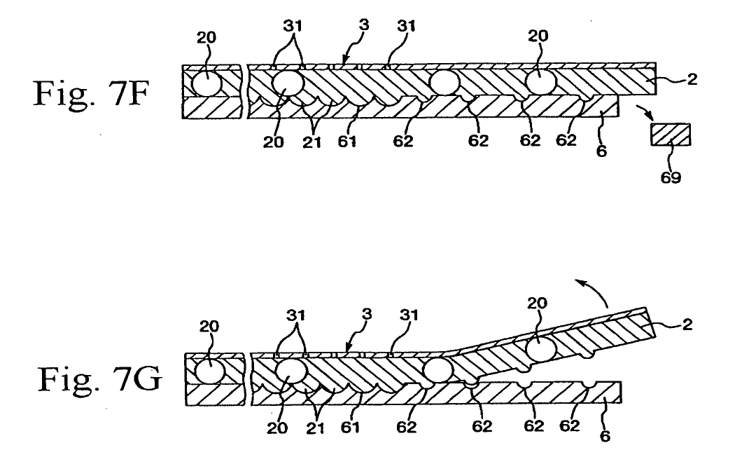

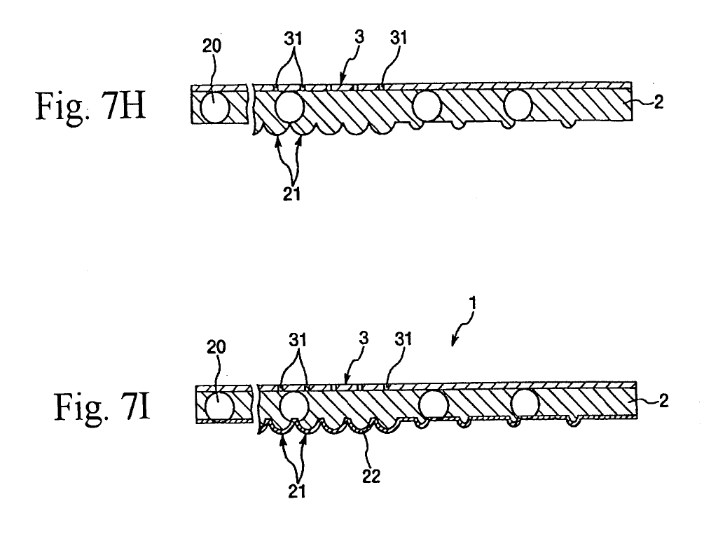

FIG. 7 is a longitudinal cross-sectional view which schematically shows one example of a method of manufacturing a microlens substrate 1 shown in FIG. 1. Now, in following explanations using FIG. 7, for convenience of explanation, a lower side and an upper side in FIG. 7 are referred to as “light incident side” and “light emission side”, respectively.

<B1> As shown in FIG. 7A, a resin material 23 having fluidity (for example, a resin material 23 at a softened state, a non-polymerized (uncured) resin material 23) is supplied to the surface of the member 6 with concave portions on which the first concave portions 61 and the second concave portions 62 are formed, and the resin material 23 is then pressed by means of a flat plate 11. In particular, in the present embodiment, the resin material 23 is pressed (or pushed) by means of the flat plate 11 while spacers 20 are provided between the member 6 with concave portions and the flat plate 11. Thus, it is possible to control the thickness of the formed microlens substrate 1 more surely, and this makes it possible to control the focal points of the respective microlenses 21 in the microlens substrate 1 finally obtained more surely. In addition, it is possible to prevent disadvantage such as color heterogeneity from being generated more efficiently.

Each of the spacers 20 is formed of a material having an index of refraction nearly equal to that of the resin material 23 (the resin material 23 at a solidified state). By using the spacers 20 formed of such a material, it is possible to prevent the spacers 20 from having a harmful influence on the optical characteristics of the obtained microlens substrate 1 even in the case where the spacers 20 are arranged in portions in each of which any first concave portion 61 of the member 6 with concave portions is formed. This makes it possible to provide a relatively large number of spacers 20 in a wide region of one major surface of the member 6 with concave portions. As a result, it is possible to get rid of the influence due to flexure of the member 6 with concave portions and/or the flat plate 11, or the like efficiently, and this makes it possible to control the thickness of the obtained microlens substrate 1 more surely.

Although the spacers 20 are formed of the material having an index of refraction nearly equal to that of the resin material 23 (the resin material 23 at a solidified state) as described above, more specifically, it is preferable that the absolute value of the difference between the absolute index of refraction of the constituent material of the spacer 20 and the absolute index of refraction of the resin material 23 at a solidified state is 0.20 or less, and more preferably it is 0.10 or less. Further more preferably it is 0.02 or less, and most preferably the spacer 20 is formed of the same material as that of the resin material 23 at a solidified state.

The shape of each of the spacers 20 is not particularly limited. It is preferable that the shape of each of the spacers 20 is a substantially spherical shape or a substantially cylindrical shape. In the case where each of the spacers 20 has such a shape, it is preferable that the diameter of the spacer 20 is in the range of 10 to 300 μm, and more preferably it is in the range of 30 to 200 μm. Further more preferably, it is in the range of 30 to 170 μm.

In this regard, in the case of using the spacers 20 as described above, the spacers 20 may be provided between the member 6 with concave portions and the flat plate 11 when solidifying the resin material 23. Thus, the timing to supply the spacers 20 is not particularly limited. Further, for example, a resin material 23 in which the spacers 20 are dispersed in advance may be utilized as a resin material to be supplied onto the surface of the member 6 with concave portions on which the first concave portions 61 are formed, or the resin material 23 may be supplied thereon while the spacers 20 are provided on the surface of the member 6 with concave portions. Alternatively, the spacers 20 may be supplied onto the surface of the member 6 with concave portions after supplying the resin material 23 thereto.

The resin material 23 is generally formed of a material corresponding to the constituent material of the main substrate 2 described above. Further, for example, any of a polymerization initiator, a hardening antiblocking agent (for example, an amine based compound), a dispersant, a solvent, a diffusing agent (for example, beads-shaped glass, silica, an inorganic based oxide, an inorganic based carbonation, an inorganic based sulfate, an organic based resin and the like), an ultraviolet absorber, a light stabilizer, a surfactant, an antifoam agent, an antistatic agent, an oxidation inhibitor, a fire retardant and the like may be included in the resin material 23. For example, in the case where the resin material includes a diffusing agent, it is possible to improve the angle of view characteristics of the transmission screen 10 to which the microlens substrate 1 is applied as described above. Further, for example, since it is possible to improve the angle of view characteristics of a screen of the transmission screen 10 even though the configuration of a diffusion plate or the like is omitted, it is possible to make the transmission screen 10 and/or the rear projection 300 thinner.

Further, in the invention, when applying the resin material 23 onto the member 6 with concave portions, a removable member 69 for assisting to release the microlens substrate 1 from the member 6 with concave portions is provided at one end portion of the member 6 with concave portions, and the resin material 23 is applied onto the member 69.

In the case where the member 69 is used when supplying (applying) the resin material 23 onto the member 6 with concave portions in this way, it is possible to grasp the vicinity of one end portion of the main substrate 2 to be formed surely by removing the member 69 at the subsequent process (that is, a process to release the main substrate 2 from the member 6 with concave portions). As a result, it is possible to prevent relatively great stress from being added to the vicinity of any second concave portions 62 and any corresponding convex portions of the main substrate 2 at the process to release the main substrate 2 from the member 6 with concave portions, and it is possible to start and proceed the release of the main substrate (member with convex portions) 2 more smoothly. In addition, it is possible to improve the stability of the shape of each of the second convex portions 62, and it is possible to improve the endurance of the member 6 with concave portions particularly.

Although the member 69 may be formed of any material, it is preferable that the adhesion of the member 69 to the resin material 23 (that is, resin material 23 solidified after being supplied thereon while it has fluidity) is smaller than the adhesion of the member 6 with concave portions to the resin material 23.

The width of the member 69 (the length of the member 69 in the release direction of the main substrate 2, that is, the length indicated by L₆ in FIG. 7A) is not particularly limited. For example, it is preferable that the width of the member 69 is in the range of 0.5 to 200 mm. More preferably it is in the range of 5 to 100 mm, and further more preferably it is in the range of 10 to 50 mm. In the case where the width of the member 69 is restricted within the above ranges, it is possible to achieve the effects as described above sufficiently and remarkably while preventing the unusable lens region of the microlens substrate 1 from being enlarged more than necessary. In addition, it is possible to improve the stability of the shape of each of the second convex portions 62, and it is possible to improve the endurance of the member 6 with concave portions particularly further.

Further, a mold release agent or the like may be applied onto the surface of the member 6 with concave portions on which the first concave portions 61 and the second concave portions 62 are formed and/or the surface of the flat plate 11 with which the resin material 23 is pressed. This makes it possible to separate the microlens substrate 1 (main substrate 2) from the member 6 with concave portions and the flat plate 11 easily and surely at the following steps. As for the mold releasing process, formation of a film formed of a material having mold release ability, for example, fluorine-containing organic silicon compound, silicone based compound such as alkylpolysiloxane, fluorine based compound such as polytetrafluoroethylene, and alkyl quaternary ammonium salt; surface treatment by means of silylate materials by silylating agent such as hexamethyldisilazane ([(CH₃)₃Si]₂NH), surface treatment by means of fluorine based gas or the like may be mentioned.

<B2> Next, the resin material 23 is solidified (in this regard, including hardened (polymerized)), and then the flat plate 11 is removed (see FIG. 7B). In this way, the main substrate 2 provided with the plurality of microlenses 21 (in particular, microlenses 21 which satisfy the conditions as described above such as shape, arrangement and the like) constituted from the resin material 23 filled in the plurality of first concave portions 61 each of which serves as a convex lens is obtained. By solidifying the resin material 23, convex portions corresponding to the second concave portions 62 are formed in addition to the microlenses 21. Such convex portions may be removed from the microlens substrate 1 to be finally manufactured. Alternatively, such convex portions may have a function as lenses.

In the case where the solidification of the resin material 23 is carried out by being hardened (polymerized), the method thereof is not particularly limited, and it is appropriately selected according to the kind of the resin material. For example, irradiation with light such as ultraviolet rays, heating, electron beam irradiation, or the like may be mentioned.

In this regard, it is preferable that the hardness of the cured resin material 23 is in the range of shore D 80 to 20, and more preferably it is in the range of shore D 60 to 30. In the case where the hardness of the resin material 23 is restricted within the above ranges, the main substrate (member with convex portions) 2 can have sufficient hardness, and it is possible to restrain increase of the stress when releasing the main substrate 2 from the member 6 with concave portions as a mold. In addition, it is possible to improve the stability of the concavo-convex pattern of the main substrate 2 (that is, the stability of the shape thereof) particularly.

<B3> Next, a process that a black matrix 3 is formed on the light emission surface of the main substrate 2 manufactured as described above will be described.

First, as shown in FIG. 7C, a positive type photopolymer 32 having light shielding (blocking) effect is supplied onto the light emission surface of the main substrate 2. As the method of supplying the positive type photopolymer 32 onto the light emission surface of the main substrate 2, for example, various types of coating methods such as a dip coat method, a doctor blade method, a spin coat method, a blush coat method, a spray coating, an electrostatic coating, an electrodeposition coating, roll coater, and the like can be utilized. The positive type photopolymer 32 may be constituted from a resin having light shielding (blocking) effect, or may be one in which a material having light shielding (blocking) effect is dispersed or dissolved to a resin material having low light shielding (blocking) effect. Heat treatment such as a pre-bake process, for example, may be carried out after supplying the positive type photopolymer 32 if needed.

<B4> Next, as shown in FIG. 7D, light Lb for exposure is irradiated to the main substrate 2 in a direction perpendicular to the light incident surface of the main substrate 2. The irradiated light Lb for exposure is condensed by passing through each of the microlenses 21. The positive type photopolymer 32 in the vicinity of the focal point f of each of the microlenses 21 is exposed, and the positive type photopolymer 32 corresponding to portions other than the vicinity of the focal points f is not exposed or slightly exposed (that is, the degree of exposure is small). In this way, only the positive type photopolymer 32 in the vicinity of the respective focal points f is exposed.

The development is then carried out. In this case, since the photopolymer 32 is a positive type photopolymer, the exposed photopolymer 32 in the vicinity of the respective focal points f is melt and removed by the development. As a result, as shown in FIG. 7E, the black matrix 3 in which the openings 31 are formed on the portions corresponding to the optical axes L of the microlenses 22 is provided. The developing method may be selected arbitrarily depending on composition of the positive type photopolymer 32 or the like. For example, the development of the positive type photopolymer 32 in the present embodiment can be carried out using an alkaline aqueous solution such as a solution of potassium hydroxide or the like.

In this way, in the method of manufacturing a microlens substrate 1 of the present embodimentince the black matrix 3 is formed by irradiating the photopolymer 32 with the light for exposure condensed by the plurality of microlenses 21, it is possible to form the black matrix 3 with simpler process compared with the case of using a photolithography technology, for example.

Further, heat treatment such as a post-bake process may be carried out after exposing the positive type photopolymer 32 if needed.

<B5> Next, the main substrate (member with convex portions) 2 is released from the member 6 with concave portions.

First, as shown in FIG. 7F, by removing the member 69 from the member 6 with concave portions, the member 69 is separated from the main substrate 2. Thus, one end portion of the main substrate 2 corresponding to the member 69 is led to the state where it is separated from the member 6 with concave portions. By using the member 69 in this way, it is possible to grasp the vicinity of the end portion of the main substrate 2 to be formed surely. As a result, it is possible to prevent relatively great stress from being added to the vicinity of any second concave portions 62 of the member 6 with concave portions and/or any corresponding convex portions to be formed of the member with convex portions efficiently. In addition, it is possible to prevent relatively great stress from being added to the vicinity of any first concave portions 61 of the member 6 with concave portions and/or any corresponding microlenses 21 to be formed of the member with convex portions efficiently, and it is possible to start and proceed the release of the main substrate (member with convex portions) 2 more smoothly. Further, it is possible to improve the stability of the shape of each of the second convex portions 62, and it is possible to improve the endurance of the member 6 with concave portions particularly.

As shown in FIG. 7G, the main substrate 2 is bent when releasing the main substrate 2 from the member 6 with concave portions.

Further, when releasing the main substrate 2 from the member 6 with concave portions, the release direction is a short axis direction of each of the first concave portions 61 in the member 6 with concave portions. This makes it possible to reduce the stress to the member 6 with concave portions and the main substrate 2 during the release further, and it is possible to prevent defects of the concavo-convex pattern of them from being generated.

Moreover, when releasing the main substrate 2 from the member 6 with concave portions, it is preferable to release the main substrate 2 at substantially constant speed and consecutively (without interruption). This makes it possible to release the main substrate 2 more stably. Furthermore, in the case where there is interruption of a release operation, the stress added to the member 6 with concave portions and/or main substrate 2 at the restart of the release operation is made to increase, and therefore, there is a possibility that the effects as described above are not achieved sufficiently.

Since the second concave portions 62 are provided in the member 6 with concave portions as described above, it is possible to release the main substrate 2 from the member 6 with concave portions with relatively small force easily and surely (while preventing the defects such as crack from being generated in the concavo-convex pattern sufficiently).

Although the release speed is not particularly limited, for example, it is preferable that the release speed is in the range of 0.1 to 500 mm/second. More preferably it is in the range of 1 to 100 mm/second, and further more preferably it is in the range of 10 to 50 mm/second. In the case where the release speed is restricted within the above ranges, it is possible to carry out the release operation more stably. On the other hand, in the case where the release speed is below the lower limit given above, it takes much time to release the main substrate 2 from the member 6 with concave portions, and therefore, there is a possibility that it is disadvantage in view of the productivity of the microlens substrate 1 (main substrate 2). Further, in the case where the release speed is over the upper limit given above, the stress to the member 6 with concave portions and the main substrate 2 is made to increase, and therefore, there is a possibility that the effects as described above are not achieved sufficiently.

Although the force (tensile strength) when releasing the main substrate 1 from the member 6 with concave portions is not particularly limited, for example, it is preferable that the force (tensile strength) is in the range of 5 to 1,000 g/cm (width). More preferably it is in the range of 8 to 700 g/cm (width), and further more preferably it is in the range of 10 to 500 g/cm (width). By restricting the force (tensile strength) within the above ranges, it is possible to carry out the release operation stably. On the other hand, in the case where the force (tensile strength) is below the lower limit given above, it takes much time to release the main substrate 2 from the member 6 with concave portions, and therefore, there is a possibility that it is disadvantage in view of the productivity of the microlens substrate 1 (main substrate 2). Further, in the case where the force (tensile strength) is over the upper limit given above, the stress to the member 6 with concave portions and the main substrate 2 is made to increase, and therefore, there is a possibility that the effects as described above are not achieved sufficiently.

In this way, a main substrate (member with concave portions) 2 on the light emission surface of which the black matrix 3 is provided is obtained as shown in FIG. 7H.

<B6> Then, by supplying a coloring liquid onto the main substrate 2 that has been released from the member 6 with concave portions, a colored portion 22 is formed thereon, whereby a microlens substrate 1 is obtained (see FIG. 7I).

The coloring liquid is not particularly limited, and in the present embodiment, the coloring liquid is one containing a coloring agent and benzyl alcohol. The invention found that it is possible to carry out the coloring of the main substrate easily and surely by using such a coloring liquid. In particular, according to the processes, it is possible to subject a main substrate 2 formed of a material such as an acrylic based resin which it is difficult to color in a conventional coloring method to a coloring process easily and surely. It is thought that this is for the following reasons.

Namely, by using the coloring liquid containing benzyl alcohol, the benzyl alcohol in the coloring liquid penetrates the main substrate 2 deeply and diffuses therein, whereby the bonding of molecules (the bonding between the molecules) constituting the main substrate 2 is loosened, and spaces in which the coloring agent is to penetrate are secured. The benzyl alcohol and the coloring agent in the coloring liquid are replaced, by which the coloring agent is held in the spaces (which can be likened to seats for the coloring agent (coloring seats)), and therefore, the surface of the main substrate 2 is colored.

Further, by using the coloring liquid as described above, it is possible to form the colored portion 22 having an even thickness easily and surely. In particular, even though a main substrate (that is, work) to be colored is one in which a minute structure such as microlenses is provided on the surface thereof (one in which a cycle of unevenness in a two-dimensional direction of the surface thereof is small) or one in which the region to be colored is a large area, it is possible to form the colored portion 22 with an even thickness (that is, without color heterogeneity).

As the method of supplying the coloring liquid onto the light incident surface of the main substrate 2, for example, various types of coating methods such as a doctor blade method, a spin coat method, a blush coat method, a spray coating, an electrostatic coating, an electrodeposition coating, printing, roll coater, and a dipping method in which the main substrate 2 is immersed (soaked) in the coloring liquid, and the like may be mentioned. The dipping method (in particular, dip dyeing) is suitable among these methods. This makes it possible to form the colored portion 22 (in particular, the colored portion 22 having an even thickness) easily and surely. Further, in particular, in the case where the coloring liquid is supplied onto the main substrate 2 by means of dip dyeing, it is possible to color even a main substrate 2 formed of a material such as an acrylic based resin which it is difficult to color in a conventional coloring method easily and surely. It is thought that this is because the dye that can be used for dip dyeing has high affinity to an ester group (ester bonding) that acrylic based resin or the like has.

It is preferable that the coloring liquid supplying step is carried out while the coloring liquid and/or the main substrate 2 are heated at the range of 60 to 100° C. This makes it possible to form the colored portion 22 efficiently while preventing a harmful influence (for example, deterioration of the constituent material of the main substrate 2) on the main substrate 2 on which the colored portion 22 is to be formed from being generated sufficiently.

Further, the coloring liquid supplying step may be carried out while the ambient pressure is heightened (with application of pressure). This makes it possible to accelerate the penetration of the coloring liquid into the inside of the main substrate 2, and as a result, it is possible to form the colored portion 22 efficiently with a short time.

In this regard, the step of supplying the coloring liquid may be carried out repeatedly (that is, multiple times) if needed (for example, in the case where the thickness of the colored portion 22 to be formed is relatively large). Further, the main substrate 2 may be subjected to heat treatment such as heating, cooling and the like, irradiation with light, pressurization or decompression of the atmosphere, or the like after supplying the coloring liquid if needed. This makes it possible to accelerate the fixing (stability) of the colored portion 22.

Hereinafter, the coloring liquid used at the present step will be described in detail.

The content by percentage of the benzyl alcohol in the coloring liquid is not particularly limited. It is preferable that the content by percentage of the benzyl alcohol is in the range of 0.01 to 10.0% by weight. More preferably it is in the range of 0.05 to 8.0% by weight, and further more preferably it is in the range of 0.1 to 5.0% by weight. In the case where the content by percentage of benzyl alcohol is restricted within the above ranges, it is possible to form the suitable colored portion 22 easily and surely while preventing a harmful influence (such as deterioration of the constituent material of the main substrate 2) on the main substrate 2 on which the colored portion 22 is to be formed from being generated more efficiently.

The coloring agent contained in the coloring liquid may be any one such as various dyes and various pigments, but it is preferable that the coloring agent is a dye. More preferably it is a disperse dye and/or a cationic dye, and further more preferably it is a disperse dye. This makes it possible to form the colored portion 22 efficiently while preventing a harmful influence on the main substrate 2 on which the colored portion 22 is to be formed (for example, deterioration of the constituent material of the main substrate 2) from being generated sufficiently. In particular, it is possible to color even a main substrate 2 formed of a material such as an acrylic based resin which it is difficult to color in a conventional coloring method easily and surely. It is thought that this is because it is easy to color such a material because the coloring agent as described above uses ester functions (ester bonding) that acrylic based resin or the like has as the coloring seats.

As described above, although the coloring liquid used in the present embodiment contains at least the coloring agent and benzyl alcohol, it is preferable that the coloring liquid further contains at least one compound selected from the benzophenone based compound and the benzotriazole based compound and benzyl alcohol. This makes it possible to form the colored portion 22 more efficiently while preventing a harmful influence (for example, deterioration of the constituent material of the main substrate 2) on the main substrate 2 on which the colored portion 22 is to be formed from being generated sufficiently. It is thought that this is for the following reasons.

Namely, by using the coloring liquid containing benzyl alcohol, and at least one kind of compound selected from a benzophenone based compound and a benzotriazole based compound (hereinafter, benzyl alcohol, the benzophenone based compound and the benzotriazole based compound are collectively referred to as “additives”), the additives in the coloring liquid penetrates the main substrate 2 and diffuses therein, whereby the bonding of molecules (the bonding between the molecules) constituting the main substrate 2 is loosened, and spaces in which the coloring agent is to penetrate are secured. The additives and the coloring agent are replaced, by which the coloring agent is held in the spaces (which can be likened to seats for the coloring agent (coloring seats)), and therefore, the surface of the main substrate 2 is colored. It is thought that this is because, by using the at least one compound selected from the benzophenone based compound and the benzotriazole based compound and benzyl alcohol together, they interact with each other in a complementary manner, and the coloring by the coloring liquid becomes good.

As for the benzophenone based compound, a compound having a benzophenone skeleton, its tautomers, or these inductors (for example, addition reaction products, substitution reaction products, reductive reaction products, oxidation reaction products and the like) can be utilized.

As for such compounds, for example, benzophenone, 2,4-dihydroxybenzophenone, 2-hydroxy-4-methoxybenzophenone, 2,2′-dihydroxy-4,4,′-dimethoxybenzophenone, 2,2′,4,4,′-tetrahydroxybenzophenone, 2-hydroxy-4-octylbenzophenone, 4-benzyloxy-2-hydroxybenzophenone, benzophenone anil, benzophenone oxime, benzophenone chloride (α, α′-dichlorodiphenylmethane) and the like may be mentioned. The compound that has benzophenone skeleton is preferable among these compounds, and more preferably the compound is any one of 2,2′-dihydroxy-4,4,′-dimethoxybenzophenone and 2,2′,4,4′-tetrahydroxybenzophenone. By using such a benzophenone based compound, the effects as described above appear remarkably.

Further, as for the benzotriazole based compound, a compound having a benzotriazole skeleton, its tautomers, or these inductors (for example, addition reaction products, substitution reaction products, reductive reaction products, oxidation reaction products and the like) can be utilized.

As for such compounds, for example, benzotriazole, 2-(2-hydroxy-5-methylphenyl)-2H-benzotriazole, 2-(2-hydroxy-4-octyloxyphenyl)-2H-benzotriazole and the like may be mentioned. The compound that has benzotriazole skeleton is preferable among these compounds, and more preferably the compound is any one of 2-(2-hydroxy-5-methylphenyl)-2H-benzotriazole and 2-(2-hydroxy-4-octyloxyphenyl)-2H-benzotriazole. By using such a benzotriazole based compound, the effects as described above appear remarkably.

In the case where the benzophenone based compound and/or the benzotriazole based compound is contained in the coloring liquid, the total content by percentage of the benzophenone based compound and the benzotriazole based compound in the coloring liquid is not particularly limited. It is preferable that the total content by percentage of the benzophenone based compound and the benzotriazole based compound in the coloring liquid is in the range of 0.001 to 10.0% by weight. More preferably it is in the range of 0.005 to 5.0% by weight, and further more preferably it is in the range of 0.01 to 3.0% by weight. In the case where the total content by percentage of the benzophenone based compound and the benzotriazole based compound is restricted within the above ranges, it is possible to form the suitable colored portion 22 easily and surely while preventing a harmful influence (such as deterioration of the constituent material of the main substrate 2) on the main substrate 2 on which the colored portion 22 is to be formed from being generated more efficiently.

Further, in the case where the benzophenone based compound and/or the benzotriazole based compound is contained in the coloring liquid, and the content by percentage of the benzophenone-based compound in the coloring liquid is defined as X (% by weight) and the total content by percentage of the benzophenone based compound and the benzotriazole based compound in the coloring liquid is defined as Y (% by weight), then it is preferable that X and Y satisfy the relation: 0.001≦X/Y≦10000. More preferably X and Y satisfy the relation: 0.05≦X/Y≦1000, and further more preferably X and Y satisfy the relation: 0.25≦X/Y≦500. In the case where X and Y satisfy the relations as described above, synergistic effects by using the benzophenone based compound and/or the benzotriazole based compound together with benzyl alcohol are exerted more remarkably. In addition, it is possible to form the suitable colored portion 22 with a high speed easily and surely while preventing a harmful influence (such as deterioration of the constituent material of the main substrate 2) on the main substrate 2 on which the colored portion 22 is to be formed from being generated more efficiently.

Further, it is preferable that the coloring liquid further contains benzyl alcohol and a surfactant. This makes it possible to disperse the coloring agent stably and evenly even under the conditions in which benzyl alcohol exists. Even though the main substrate 2 onto which the coloring liquid is to be supplied is formed of a material such as an acrylic based resin that it is difficult to color in a conventional method, it is possible to color the main substrate 2 easily and surely. As for a surfactant, nonionic surfactants, anionic surfactants, cationic surfactants, ampholytic surfactants and the like may be mentioned. As for the nonionic surfactant, for example, ether based surfactants, ester based surfactants, ether ester based surfactants, nitrogenous based surfactants and the like may be mentioned. More specifically, polyvinyl alcohol, carboxymethylcellulose, polyethylene glycol, acrylic ester, methacrylic ester, and the like may be mentioned. Further, as for anionic surfactants, for example, various kinds of rosins, various kinds of carboxylates, various kinds of ester sulfates, various kinds of sulfonates, various kinds of ester phosphates, and the like may be mentioned. More specifically, gum rosin, polymerized rosin, disproportionated rosin, maleic rosin, fumaric rosin, maleic rosin pentaester, maleic rosin glycerolester, tristearate (for example, metal salt such as aluminum salt), distearate (for example, metal salt such as aluminum salt, barium salt), stearate (for example, metal salt such as calcium salt, lead salt, zinc lead salt), linolenate (for example, metal salt such as cobalt salt, manganese salt, lead salt, zinc salt), octanoate (for example, metal salt such as aluminum salt, calcium salt, cobalt salt), oleate (for example, metal salt such as calcium salt, cobalt salt), palmitate (metal salt such as zinc salt), naphthenate (for example, metal salt such as calcium salt, cobalt salt, manganese salt, lead salt, zinc salt), resinate (for example, metal salt such as calcium salt, cobalt salt, manganese salt, zinc salt), polyacrylate (for example, metal salt such as sodium salt), polymethacrylate (for example, metal salt such as sodium salt), polymaleate (for example, metal salt such as sodium salt), acrylate-maleate copolymer (for example, metal salt such as sodium salt), cellulose, dodecylbezenesulfonate (for example, metal salt such as sodium salt), alkylsulfonate salt, polystyrenesulfonate, (for example, (for example, metal salt such as sodium salt), alkyldiphenyletherdisulfonate (for example, metal salt such as sodium salt), and the like may be mentioned. Further, as for cationic surfactants, for example, various kinds of ammonium salts such as primary ammonium salt, secondary ammonium salt, tertiary ammonium salt, quaternary ammonium salt may be mentioned. More specifically, monoalkylamine salt, dialkylamine salt, trialkylamine salt, tetraalkylamine salt, benzalkonium salt, alkylpyridinium salt, imidazolium salt, and the like may be mentioned. Further, as for ampholytic surfactants, for example, various kinds of betaines such as carboxybetaine, sulfobetaine, various kinds of aminocarboxylic acids, various kinds of ester phosphate salts, and the like may be mentioned.

Hereinafter, a description will be given for a rear projection using the transmission screen described above.

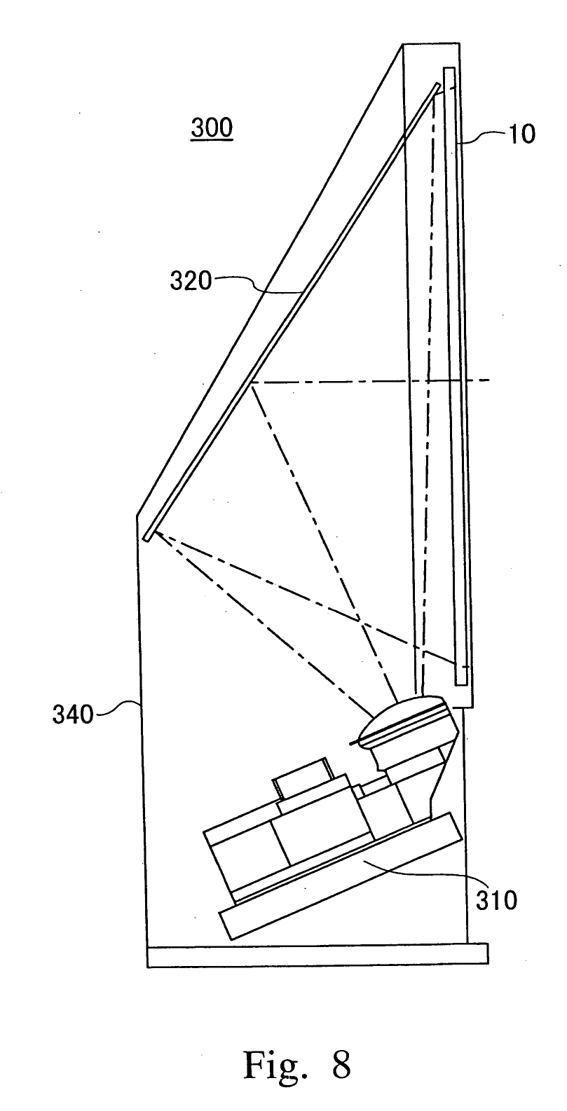

FIG. 8 is a drawing which schematically shows the configuration of a rear projection 300 to which the transmission screen 10 of the invention is applied. As shown in FIG. 8, the rear projection 300 has a structure in which a projection optical unit 310, a light guiding mirror 320 and a transmission screen 10 are arranged in a casing 340.

Since the rear projection 300 uses the transmission screen 10 that has excellent angle of view characteristics and light use efficiency as described above, it is possible to obtain image having excellent contrast. In addition, since the rear projection 300 has the structure as described above in the present embodiment, it is possible to obtain excellent angle of view characteristics and light use efficiency, in particular.

Further, since the microlenses 21 each having a substantially ellipse shape are arranged in a houndstooth check manner on the microlens substrate 1 described above, the rear projection 300 hardly generates problems such as moire, in particular.

As described above, it should be noted that, even though the member 6 with concave portions, the method of manufacturing a member 6 with concave portions, the member with convex portions (microlens substrate 1), the transmission screen 10 and the rear projection 300 according to the invention have been described with reference to the preferred embodiment shown in the accompanying drawings, the invention is not limited to these embodiment. For example, each element (component) constituting the microlens substrate 1, the transmission screen 10 and the rear projection 300 may be replaced with one capable of performing the same or a similar function.

Further, in the embodiment described above, even though it has been described that the spacers 20 each having an index of refraction nearly equal to that of the resin material 23 (that is, the resin material 23 after solidification) are used as spacers, each of the spacers 20 having an index of refraction nearly equal to that of the resin material 23 (that is, the resin material 23 after solidification) is not required in the case where the spacers 20 are arranged only in the region where no first concave portions 61 of the member 6 with concave portions are formed (unusable lens area). Moreover, the spacers 20 as described above do not always have to be utilized in manufacturing the microlens substrate (member with convex portions) 1.

Moreover, in the embodiment described above, even though it has been described that the resin material 23 is supplied onto the surface of the member 6 with concave portions, the microlens substrate 1 may be manufactured so that, for example, the resin material 23 is supplied onto the surface of the flat plate 11 and the resin material 23 is then pressed by the member 6 with concave portions.

Furthermore, in the embodiment described above, even though it has been described that at the initial hole formation step in the method of manufacturing the member 6 with concave portions the first initial concave portions 71 were formed in the base member 7 in addition to the first initial holes 81 and the second initial holes 82, there is no need to form such first initial concave portions 71. By appropriately adjusting the formation conditions for the first initial holes 81 and the second initial holes 82 (for example, energy intensity of a laser, the beam diameter of the laser, irradiation time or the like), it is possible to form the first initial concave portions 71 each having a predetermined shape, or it is possible to selectively form only the first initial holes 81 and the second initial holes 82 so that the first initial concave portions 71 are not formed.

Further, in the embodiment described above, even though it has been described that the transmission screen 10 is provided with the microlens substrate (member with convex portions) 1 and the Fresnel lens 5, the transmission screen 10 of the invention need not be provided with the Fresnel lens 5 necessarily. For example, the transmission screen 10 may be constructed from only the member with convex portions (microlens substrate 1) of the invention practically.

Moreover, in the embodiment described above, even though it has been described that the first concave portions 61 and the second concave portions 62 whose depths are different from each other are formed by using the sealing member 88 and removing the sealing member 88 in process of the etching process, the method of forming the first concave portions 61 and the second concave portions 62 is not limited there to. For example, it is possible to form the first concave portions 61 and the second concave portions 62 whose depths are different from each other appropriately by subjecting the base member 7 to the etching process while coating a film (sealing member) that can be subjected to an etching process in the vicinity of the surface of the second initial holes 82 and not coating the film in the vicinity of the surface of the first initial holes 81. Furthermore, it is possible to form the first concave portions 61 and the second concave portions 62 whose depths are different from each other appropriately by forming the initial concave portions 71 each having a relatively deep depth at the portions corresponding to the first concave portions 61 and not forming initial concave portions at the portions corresponding to the second concave portions 62 at the initial hole formation process without using the sealing member 88 as described above, or by varying the size of each of the first and second initial holes (openings) 81 and 82 in the mask 8.

Moreover, in the embodiment described above, it has been described that the density of the second concave portions 62 is lower than the density of the first concave portions 61 and the size of each of the second concave portions 62 is smaller than the size of each of the first concave portions 61. However, the second concave portions 62 may be any one as long as the depth of each of the second concave portions 62 is shallower than the depth of each of the first concave portions 61, and the shape, the size, the arrangement pattern, the density and the like thereof are not particularly limited.

Furthermore, in the embodiment described above, even though it has been described that each of the microlenses 21 in the microlens substrate (member with convex portions) 1 and each of the first concave portions 61 in the member 6 with concave portions have a flat shape (substantially elliptic shape) and they are arranged in a houndstooth check manner, the shape and/or the arrangement pattern thereof may be any one. For example, they may be arranged in a random manner.

Further, in the embodiment described above, even though it has been described that the first region 67 is constituted only from the first concave portions 61 and the second region 68 is constituted only from the second concave portions 62, there may be a region in which the first concave portions 61 and the second concave portions 62 are intermingled.

Moreover, in the embodiment described above, even though it has been described that each of the microlenses 21 and the first concave portions 61 has a flat shape in which the perpendicular length thereof is larger than the horizontal length thereof, the shape of the microlenses 21 and the shape of the first concave portions 61 are not particularly limited. For example, it may be any one such as a substantially circular shape, a substantially hexagonal shape, and a flat shape in which the horizontal length thereof is larger than the perpendicular length thereof.

Furthermore, in the embodiment described above, even though it has been described that the convex portions corresponding to the first concave portions 61 function as microlenses 21, the convex portions corresponding to the first concave portions 61 may function as any one such as lenticular lenses, for example.

Further, in the embodiment described above, even though it has been described that the second regions 68 are provided in the vicinity of the both right and left end portions of the member 6 with concave portions, the second region 68 may be provided in the vicinity of at least one of the both end portions of the member 6 with concave portions. For example, the second region 68 may be provided at one end portion of the member 6 with concave portions (for example, right side or left side in FIG. 2). Alternatively, the second region 68 may be provided in the vicinity of the entire edge of the member 6 with concave portions.

Further, in the embodiment described above, even though it has been described that each of the member 6 with concave portions and the member with convex portions (microlens substrate 1) is a plate-shaped member (that is, substrate) (including a sheet-shaped member, a film-shaped member and the like), the shape of each of the member 6 with concave portions and the member with convex portions (microlens substrate 1) may be any one. For example, the member 6 with concave portions may be a roll-shaped member.

Moreover, the member with convex portions (microlens substrate 1) of the invention may be manufactured using the member 6 with concave portions, and the member with convex portions (microlens substrate 1) of the invention is not limited to one manufactured by means of the method as described above.

Furthermore, in the embodiment described above, even though it has been described that the member with convex portions (microlens substrate 1) is a member constituting the transmission screen 10 or the rear projection 300 and the member with concave portions is used as a mold for manufacturing the member with convex portions (microlens substrate 1), the member with convex portions (microlens substrate 1) and the member with concave portions are not limited to those to be applied described above, and it may be applied to one for any use. For example, the member with convex portions (microlens substrate 1) of the invention may be applied to a light diffusing plate, a black matrix screen, a screen (screen of a front projection) of a projection display (front projection), a constituent member of a liquid crystal light valve in a projection display (front projection) and the like.

Further, in the embodiment described above, even though it has been described that the member with convex portions (microlens substrate 1) is used after releasing it from the member 6 with concave portions, the member 6 with concave portions may be used together with the member with convex portions (microlens substrate 1), that is, without releasing the member with convex portions (microlens substrate 1) from the member 6 with concave portions (in particular, it may be used as a component of an optical apparatus such as a transmission screen 10 and a rear projection 300).

### EXAMPLE

<Manufacture of Member with Concave Portions, Member with Convex Portions and Transmission Screen>

### Example 1

A member with concave portions that was provided with a plurality of concave portions for forming microlenses was manufactured in the following manner.

First, a soda-lime glass substrate having a rectangle shape of 1.2 m (lateral)×0.7 m (longitudinal) and a thickness of 4.8 mm was prepared.

The soda-lime glass substrate was soaked in cleaning liquid containing 4% by weight ammonium hydrogen difluoride and 8% by weight sulfuric acid to carry out a 6 μm etching process, thereby cleaning its surface. Then, cleaning with pure water and drying with nitrogen (N₂) gas (for removal of pure water) were carried out.

Next, a laminated structure of chromium/chromium oxide (that is, laminated structure in which a film formed of chromium oxide was laminated on the outer circumference of a film formed of chromium) was formed on one major surface of the soda-lime glass substrate by means of a spattering method. Namely, a film for forming a mask and a back surface protective film each made of the laminated structure constructed from the film formed of chromium and the film formed of chromium oxide were formed on both surfaces of the soda-lime glass substrate, respectively. In this case, the thickness of the chromium layer is 0.02 μm, while the thickness of the chromium oxide layer is 0.02 μm.

Next, laser machining was carried out to the film for forming a mask to form a large number of first initial holes arranged in a houndstooth check manner within a region of 113 cm×65 cm at the central part of the film for forming a mask, thereby obtaining a mask. Further, a large number of second initial holes were simultaneously formed outside the region where the first initial holes were formed and within two regions of 10 cm×65 cm in the vicinity of both ends of the soda-lime glass substrate in the longitudinal direction thereof. The average width and the average length of each of the first initial holes were 2.0 μm and 2.2 μm, respectively. Further, the average width and the average length of each of the second initial holes were 2.0 μm and 2.2 μm, respectively.

In this regard, the laser machining was carried out using a YAG laser under the conditions of a beam diameter of 3.0 μm, and a scanning speed in a main scanning direction of 0.1 m/second. Further, energy intensity of the YAG laser was controlled so as to be 1 mW when forming the first initial holes and be 1 mJ when forming the second initial holes.

Moreover, the second initial holes were formed outside the region where the first initial holes were formed in a manner that the second initial holes became rarefactive gradually toward the end of the soda-lime glass substrate in the longitudinal direction thereof.

Furthermore, at this time, concave portions each having a depth of about 0.005 μm and a damaged layer (or affected layer) were formed at the portion where the first initial holes were formed on the surface of the soda-lime glass substrate.

Next, a sealing member (such as tape) having resistance to etching was applied to a region (corresponding to a second region) in which the second initial holes were formed on the mask. An adhesive tape having a base formed of polyethylene terephthalate and an adhesive layer formed of an adhesive was used as the sealing member.

Next, the soda-lime glass substrate to which the back surface protective film and sealing member were applied was subjected to a wet etching process. By removing the sealing member from the soda-lime glass substrate in the middle of the wet etching process, the second initial holes were exposed and made to be contact with an etchant.

By subjecting the soda-lime glass substrate to such an etching process, thereby forming a large number of first concave portions (concave portions for forming microlenses) and a large number of second concave portions on the major surface of the soda-lime glass substrate. The shape of each of the first concave portions was a substantially elliptic shape (flat shape) when viewed from above the major surface of the soda-lime glass substrate, while the shape of each of the second concave portions was a substantially circular shape. The large number of first concave portions thus formed had substantially the same shape as each other. The length of each of the formed first concave portions in the short axis direction (diameter) thereof, the length of each of the formed first concave portions in the long axis direction thereof, the radius of curvature and depth of each of the formed first concave portions were 54 μm, 72 μm, 37.0 μm and 36.5 μm, respectively. Further, the density of the first concave portions in the usable area in which the first concave portions were formed was 260,000 pieces/cm². Moreover, the large number of second concave portions thus formed has substantially the same shape as each other. The diameter and depth of each of the formed second concave portions were 47.0 μm and 23.5 μm, respectively. The density of the second concave portions in the usable area in which the second concave portions were formed was 100,000 pieces/cm². Further, the number of the arrays of the second concave portions in the second region is 7,000. Moreover, the average pitch of the adjacent arrays of the second portions is 100 μm. The length of the second region in the release direction was 50 mm.

In this regard, an aqueous solution containing 4% by weight ammonium hydrogen difluoride and 8% by weight hydrogen peroxide was used for the wet etching process as an etchant, and the soak time of the substrate was 2.5 hours.

Next, the mask and the back surface protective film were removed by carrying out an etching process using a mixture of ceric ammonium nitrate and perchloric acid. Then, cleaning with pure water and drying with N₂ gas (removal of pure water) were carried out.

In this way, the substrate with concave portions as shown in FIG. 4 in which the large number of first concave portions for forming microlenses were arranged in a houndstooth check manner in a first region of the major surface of the soda-lime glass substrate and the large number of second concave portions were arranged outside the first region where the first concave portions were formed in the vicinity of both ends of the soda-lime glass substrate (that is, second regions) so as to become rarefactive gradually toward the outside of the soda-lime glass substrate was obtained. A share of the first concave portions in a usable area (first region) in which the first concave portions were formed was 100% when viewed from above the one major surface of the soda-lime glass substrate. Further, a share of the second concave portions in an area (second region) in which the second concave portions were formed was 50% when viewed from above the one major surface of the soda-lime glass substrate.

Next, a mold release agent (GF-6110) was applied to the surface of the member with concave portions obtained as described above on which the first and second concave portions were formed, and a non-polymerized (uncured) acrylic based resin (PMMA resin (methacryl resin)) was applied to the same surface side. At this time, substantially spherical-shaped spacers (each having a diameter of 20 μm) formed of hardened material of the acrylic based resin (PMMA resin (methacryl resin)) were arranged over the substantially entire surface of the member with concave portions. Further, the spacers are arranged at the rate of 1 pieces/cm².

At this time, a member for assisting to release a main substrate (member with convex portions) from the member with concave portions when releasing the member with convex portions (cured resin material) was provided on one end of the main substrate (see FIG. 7). The width of the member for assisting was 20 mm.

Next, the acrylic based resin was pressed (pushed) with the major surface of a flat plate formed of soda-lime glass. At this time, this process was carried out so that air was not intruded between the member with concave portions and the acrylic based resin. Further, such a flat plate onto the surface of which a mold release agent (GF-6110) was applied was utilized as the flat plate.

Then, by heating the member with concave portions, the acrylic based resin was cured to obtain a main substrate. The index of refraction of the obtained main substrate (that is, cured acrylic based resin) was 1.50. The thickness of the obtained main substrate (except for portion where the microlenses were formed) was 22 μm. The length of each of the formed microlenses in the short axis direction thereof (pitch), the length of each of the formed microlenses in the long axis direction thereof, the radius of curvature and depth of each of the formed microlenses were 54 μm, 72 μm, 37.5 μm and 37.0 μm, respectively. Further, the share of the concave portions in a usable lens area in which the microlenses were formed was 100%. The hardness of the cured acrylic based resin was shore D 54.

Next, the flat plate was removed from the main substrate.

Next, a positive type photopolymer to which a light shielding material (carbon black) was added (PC405G: made by JSR Corporation) was supplied onto the light emission surface of the main substrate (the surface opposite to the surface thereof on which the microlenses had been formed) by means of a roll coater. The content by percentage of the light shielding material in the photopolymer was 20% by weight.

Next, the main substrate was subjected to a pre-bake process of 90°×30 minutes.

Next, ultraviolet rays of 80 mJ/cm² were irradiated through the surface opposite to the surface of the member with concave portions on which the concave portions have been formed as parallel light. Thus, the irradiated ultraviolet rays were condensed by each of the microlenses, and the photopolymer in the vicinity of the focal point f of each of the microlenses (in the vicinity of the center of a black matrix to be formed in the thickness direction thereof) was exposed selectively.

The main substrate provided with the member with concave portions was then subjected to a developing process for 40 seconds using an aqueous solution containing 0.5% by weight KOH.

Then, cleaning with pure water and drying with N₂ gas (removal of pure water) were carried out. Further, the main substrate was subjected to a post-bake process of 200° C.×30 minutes. Thus, a black matrix having a plurality of openings respectively corresponding to the microlenses was formed. The thickness of the formed black matrix was 5.0 μm.

In the following manner, the main substrate was then released from the member with concave portions.

First, the member for assisting to release the main substrate was removed from the member with concave portions, and it was also removed from the main substrate thus formed. By pulling one end portion of the main substrate so that the main substrate was bent, the main substrate was released at a predetermined constant speed consecutively (without interruption). The release direction is set to the short axis direction of each of the first concave portions (that is, longitudinal direction of the main substrate). The tensile strength at this time was set to be 80 g/cm (width), and the release speed was set to be 20 mm/second.

A coloring liquid was then supplied to the main substrate that has been released from the member with concave portions by means of dip dyeing. This process was carried out so that the whole surface on which the microlenses were formed was brought into contact with the coloring liquid, but the surface on which the black matrix has been formed was not in contact with the coloring liquid. Further, the temperature of the main substrate and the coloring liquid when supplying the coloring liquid onto the main substrate was adjusted to be 90° C. Moreover, the pressure of the atmosphere was pressurized at the coloring liquid supplying process so as to be 120 kPa. A mixture containing disperse dye (Blue) (made by Futaba Sangyo): 2 part by weight, disperse dye (Red) (made by Futaba Sangyo): 0.1 part by weight, disperse dye (Yellow) (made by Futaba Sangyo): 0.05 part by weight, benzyl alcohol: 10 part by weight, a surfactant: 2 part by weight, and pure water: 1000 part by weight was used as the coloring liquid.

After the main substrate was brought into contact with the coloring liquid for 20 minutes under the conditions as described above, the main substrate was brought out from a bath in which the coloring liquid was stored, and the main substrate was then washed and dried.

By carrying out cleaning the main substrate with pure water and drying it with N₂ gas (removal of pure water), a microlens substrate on which the colored portion has been formed was obtained. The color density of the colored portion thus formed was 70%.

Further, by carrying out the similar processes as described above using the member with concave portions repeatedly, total 100 pieces of microlens substrates were manufactured. Then, transmission screens as shown in FIG. 3 were manufactured using the first microlens substrate and the 100^{th} microlens substrate.

### Examples 2 to 5

A member with concave portions, a microlens substrate and a transmission screen were manufactured in the manner similar to those in Example 1 described above except that the shape of each of the first concave portions and each of the second concave portions that the member with concave portions had and the arrangement pattern of the first and second concave portions of the member with concave portions were changed as shown in TABLE 1 by changing any of the configuration of the mask (that is, the film for forming a mask), the conditions of the irradiation with laser beams (that is, the shape of each of the initial holes to be formed and the depth of each of the initial concave portions), the soaking time into the etchant, and the like.

### Example 6

A member with concave portions, a microlens substrate and a transmission screen were manufactured in the manner similar to those in Example 1 described above except that a member for assisting to release a main substrate from the member with concave portions was not provided at one end of the member with concave portions to start releasing the main substrate from the member with concave portions.

### Comparative Example 1

A member with concave portions, a microlens substrate and a transmission screen were manufactured in the manner similar to those in Example 1 described above except that the second concave portions were not formed in manufacturing the member with concave portions.

### Comparative Example 2

A member with concave portions, a microlens substrate and a transmission screen were manufactured in the manner similar to those in Comparative Example 1 described above except that the colored portion was not formed.

### Comparative Example 3

A member with concave portions, a microlens substrate and a transmission screen were manufactured in the manner similar to those in Example 1 described above except that the shape of each of the first concave portions and each of the second concave portions that the member with concave portions had and the arrangement pattern of the first and second concave portions of the member with concave portions were changed as shown in TABLE 1 by changing any of the conditions of the irradiation with laser beams (that is, the shape of each of the initial holes to be formed and the depth of each of the initial concave portions), the soaking time into the etchant, and the like.

A configuration of the mask used when manufacturing the member with concave portions, the shape of each of the concave portions (first and second concave portions) that the member with concave portion thus manufactured had, the arrangement pattern of the first and second concave portions, the shape of each of the manufactured microlenses that the microlens substrate thus manufactured had, the arrangement pattern of the manufactured microlenses, and the productivity of the microlens substrate (main substrate), and the like in each of Examples 1 to 6 and Comparative Examples 1 to 3 were shown in TABLE 1 as a whole.

TABLE 1

| | Mask | | | | | | | | | |
|---|---|---|---|---|---|---|---|---|---|---|
| | Surface | First Concave Portion | | | | | | Second Concave Portion | | |
| | Side/ | | | Length L₁ | Length L₂ | Depth | Density d₁ | | Depth | Density d₂ |
| | Substrate | Arrangement | | (Short Axis) | (Long Axis) | D | (thousands | Diameter | D | (thousands |
| | Side | Pattern | Shape | (μm) | (μm) | (μm) | pieces/cm2) | (μm) | (μm) | pieces/cm2) |
| Ex. 1 | Cr/CrO | HC | SE | 54 | 72 | 36.5 | 2.6 | 47 | 23.5 | 1 |
| Ex. 2 | Cr/CrO | SL | SC | 54 | 54 | 37.5 | 3.4 | 54 | 26 | 0.1 |
| Ex. 3 | Cr/CrO | HC | SE | 54 | 82 | 42 | 2.3 | 47 | 23.5 | 0.6 |
| Ex. 4 | Au/Cr | HC | SE | 54 | 90 | 47.5 | 2.1 | 54 | 26 | 0.8 |
| Ex. 5 | Cr/CrO | SL | SC | 60 | 60 | 42.5 | 2.8 | 47 | 23.5 | 1 |
| Ex. 6 | Cr/CrO | HC | SE | 54 | 72 | 36.5 | 2.6 | 47 | 23.5 | 1 |
| Co-Ex. 1 | Cr/CrO | HC | SE | 54 | 72 | 36.5 | 2.6 | — | — | — |
| Co-Ex. 2 | Cr/CrO | HC | SE | 54 | 72 | 36.5 | 2.6 | — | — | — |
| Co-Ex. 3 | Cr/CrO | HC | SE | 54 | 72 | 36.5 | 2.6 | 101 | 50.5 | 1 |

| | Microlens | | | | | |
|---|---|---|---|---|---|---|
| | | | Length L1 | Length L2 | Height | Productivity |
| | Arrangement | | (Short Axis) | (Long Axis) | H | of Main |
| | Pattern | Shape | (μm) | (μm) | (μm) | Substrate |
| Ex. 1 | HC | SE | 54 | 72 | 36 | Good |
| Ex. 2 | SL | SC | 54 | 54 | 36 | Good |
| Ex. 3 | HC | SE | 54 | 82 | 41.5 | Good |
| Ex. 4 | HC | SE | 54 | 90 | 47 | Good |
| Ex. 5 | SL | SC | 60 | 60 | 42 | Good |
| Ex. 6 | HC | SE | 54 | 72 | 36 | Good |
| Co-Ex. 1 | HC | SE | 54 | 72 | 36 | Bad |
| Co-Ex. 2 | HC | SE | 54 | 72 | 36 | Bad |
| Co-Ex. 3 | HC | SE | 54 | 72 | 36 | Bad |

SHAPE SC: Substantially Circular SE: Substantially Elliptic
ARRANGEMTNT PATTERN HC: Houndstooth Check SL: Square Lattice

As seen clearly from TABLE 1, in the invention (that is, Examples 1 to 6), it was possible to manufacture the microlens substrates with high productivity. On the other hand, in Comparative Examples 1 to 3, the productivity of the microlens substrates was extremely low. To explain this evaluation in detail, in the invention, the process to release the main substrate (that is, microlens substrate) from the member with concave portions could be carried out easily and surely. On the other hand, in Comparative Examples 1 to 3, it was difficult to release the main substrate from the member with concave portions, and great force was required for release compared with that in the invention.

<Manufacture of Rear Projection>

A rear projection as shown in FIG. 8 was manufactured (assembled) using the transmission screen manufactured in each of Examples 1 to 6 and Comparative Examples 1 to 3 described above.

<Evaluation of Endurance of Member with Concave Portions>

The surface of the member with concave portions on which the concave portions (that is, first concave portions and second concave portions) have been formed after manufacturing the 100 pieces of microlens substrates (that is, after carrying out the release of the main substrate 100 times repeatedly) in each of Examples 1 to 6 and Comparative Examples 1 to 3 was observed using a microscope. The state of concavo-convex pattern of the surface of the member with concave portions in each of Examples 1 to 6 and Comparative Examples 1 to 3 described above was evaluated on the basis of the following four-step standard.

A: No crack of the concavo-convex pattern was recognized.

B: Little crack of the concavo-convex pattern was recognized.

C: Crack of the concavo-convex pattern was slightly recognized.

D: Crack of the concavo-convex pattern was remarkably recognized.

<Evaluation of Dot Missing and Unevenness of Brightness>

A sample image was displayed on the transmission screen of the rear projection in each of Examples 1 to 6 and Comparative Examples 1 to 3 described above. The generation status of dot missing and unevenness of brightness in the displayed sample image was evaluated on the basis of the following four-step standard.

A: No dot missing and unevenness of brightness was recognized.

B: Little dot missing and unevenness of brightness was recognized.

C: At least one of dot missing and unevenness of brightness was slightly recognized.

D: At least one of dot missing and unevenness of brightness was remarkably recognized.

<Evaluation of Diffracted Light, Moire and Color Heterogeneity>

A sample image was displayed on the transmission screen of the rear projection in each of Examples 1 to 6 and Comparative Examples 1 to 3 described above. The generation status of diffracted light, moire and color heterogeneity in the displayed sample image was evaluated on the basis of the following four-step standard.

A: No diffracted light, moire and color heterogeneity was recognized.

B: Little diffracted light, moire and color heterogeneity was recognized.

C: At least one of diffracted light, moire and color heterogeneity was slightly recognized.

D: At least one of diffracted light, moire and color heterogeneity was remarkably recognized.

<Evaluation for Contrast>

The evaluation for contrast was carried out with respect to the rear projection of each of Examples 1 to 6 and Comparative Examples 1 to 3 described above.

A ratio LW/LB of front side luminance (white luminance) LW (cd/m²) of white indication when total white light having illuminance of 413 luces entered the transmission screen in the rear projection at a dark room to the increasing amount of front side luminance (black luminance increasing amount) LB (cd/m²) of black indication when a light source was fully turned off at a bright room was calculated as contrast (CNT). In this regard, the black luminance increasing amount is referred to as the increasing amount with respect to luminance of black indication at a dark room. Further, the measurement at the bright room was carried out under the conditions in which the illuminance of outside light was about 185 luces, while the measurement at the dark room was carried out under the conditions in which the illuminance of outside light was about 0.1 luces.

The contrast indicated by LW/LB in each of Examples 1 to 6 and Comparative Examples 1 to 3 was evaluated on the basis of the following four-step standard.

A: The contrast indicated by LW/LB is 500 or more.

B: The contrast indicated by LW/LB is in the range of 400 to 500.

C: The contrast indicated by LW/LB is in the range of 300 to 400.

D: The contrast indicated by LW/LB is 300 or less.

<Measurement of Angle of View>

The measurement of angles of view in both horizontal and vertical directions was carried out while a sample image was displayed on the transmission screen in the rear projection of each of Examples 1 to 6 and Comparative Examples 1 to 3. The measurement of the angles of view was carried out under the conditions in which the measurement was carried out at intervals of one degree with a gonio photometer. These results of the measurement of angles of view were shown in TABLE 2 as a whole.

TABLE 2

| | | | | | | | Angle of View(°) | |
|---|---|---|---|---|---|---|---|---|
| | Endurance of | | | | Color | | Half Value | |
| | Member with | | | Dot Missing | Heterogeneity | | Vertical | Horizontal |
| | Concave Portions | | | and the like | and the like | Contrast | Direction | Direction |
| EX. 1 | A | 1 | Piece | A | A | A | 22 | 24 |
| | | 100 | Piece | A | A | A | 22 | 24 |
| EX. 2 | A | 1 | Piece | A | A | A | 20 | 23 |
| | | 100 | Piece | A | A | A | 20 | 23 |
| EX. 3 | A | 1 | Piece | B | B | A | 20 | 22 |
| | | 100 | Piece | B | B | A | 20 | 22 |
| EX. 4 | A | 1 | Piece | A | A | A | 19 | 21 |
| | | 100 | Piece | A | A | A | 19 | 21 |
| EX. 5 | B | 1 | Piece | B | B | A | 18 | 21 |
| | | 100 | Piece | B | B | B | 18 | 21 |
| EX. 6 | B | 1 | Piece | A | B | A | 16 | 22 |
| | | 100 | Piece | A | B | B | 16 | 22 |
| Co-Ex. 1 | D | 1 | Piece | C | B | A | 17 | 20 |
| | | 100 | Piece | D | C | C | 16 | 18 |
| Co-Ex. 2 | D | 1 | Piece | B | A | C | 18 | 20 |
| | | 100 | Piece | C | C | D | 16 | 18 |
| Co-Ex. 3 | D | 1 | Piece | B | C | C | 18 | 20 |
| | | 100 | Piece | C | D | D | 16 | 18 |

As seen clearly from TABLE 2, no crack of the concavo-convex pattern was recognized in the members with concave portions according to the invention even after carrying out the manufacture of the members with convex portions (microlens substrates) (that is, the release of the main substrates) repeatedly. Further, the image having an excellent image quality without dot missing, unevenness of brightness, diffracted light, moire, color heterogeneity and the like was obtained according to the invention. Moreover, the rear projection in each of Examples 1 to 6 according to the invention had excellent contrast and excellent angle of view characteristics. In other words, an excellent image could be displayed on each of the rear projections of the invention stably. In particular, excellent results were obtained even in the transmission screen and the rear projection provided with the microlens substrate that has been manufactured after using the member with concave portions repeatedly.

On the other hand, in each of Comparative Examples 1 to 3, any cracks of the concavo-convex pattern were recognized in the member with concave portions that has been used for manufacturing the microlens substrates (releasing the main substrates) repeatedly. Further, sufficient results were also not obtained in the transmission screen and the rear projection manufactured using the obtained main substrate (microlens substrate). It was thought that this was because by generating the defects of the concavo-convex pattern such as cracks in the member with concave portions, it was impossible to form the microlenses having a desired shape in the manufactured microlens substrate, or the defects of the concavo-convex pattern such as cracks were generated in any microlenses of the microlens substrate when releasing the main substrate from the member with concave portions.

What is claimed is:

1. A member with concave portions used to manufacture a member with convex portions, each of the member with concave portions and the member with convex portions having two major surfaces, a plurality of convex portions being formed on one of the two major surfaces of the member with convex portions, the member with concave portions comprising:
a first region provided on one of the two major surfaces of the member with concave portions, a plurality of first concave portions being formed in the first region and used to form the plurality of convex portions of the member with convex portions; and
a second region provided on the one major surface of the member with concave portions, the second region being located adjacent to the first region, a plurality of second concave portions being formed in the second region, the depth of each of the plurality of second concave portions being shallower than the depth of each of the plurality of first concave portions.

2. The member with concave portions as claimed in claim 1, wherein the member with convex portions is a microlens substrate provided with a plurality of microlenses as the plurality of convex portions.

3. The member with concave portions as claimed in claim 1, wherein the depth of each of the plurality of first concave portions is in the range of 8 to 500 μm.

4. The member with concave portions as claimed in claim 1, wherein the depth of each of the plurality of second concave portions is in the range of 5 to 400 μm.

5. The member with concave portions as claimed in claim 1, wherein, in the case where the depth of each of the plurality of first concave portions is defined as D₁ (μm) and the depth of each of the plurality of second concave portions is defined as D₂ (μm), then D₁ and D₂ satisfy the relation: 3≦D₁−D₂≦495.

6. The member with concave portions as claimed in claim 1, wherein each of the plurality of first concave portions has a substantially elliptic shape when viewed from above the one major surface of the member with concave portions.

7. The member with concave portions as claimed in claim 1, wherein the member with concave portions is formed of a material having transparency.

8. The member with concave portions as claimed in claim 6, wherein, in the case where the length of each of the plurality of first concave portions in the short axis direction thereof is defined as L₁ (μm) and the length of each of the plurality of first concave portions in the long axis direction thereof is defined as L₂ (μm), then L₁ and L₂ satisfy the relation: 0.10≦L₁/L₂≦0.99.

9. A method of manufacturing a member with convex portions, the member with convex portions being manufactured using the member with concave portions defined by claim 1.

10. The method as claimed in claim 9, the method comprises the steps of:
preparing the member with concave portions;
supplying a resin material having fluidity onto one major surface of the member with concave portions on which the plurality of first and second concave portions are formed;
solidifying the resin material to form a base member; and
releasing the base member from the member with concave portions.

11. The method as claimed in claim 10, wherein the base member releasing step includes the steps of:
releasing the base member from the second region of the member with concave portions; and
releasing the base member from the first region of the member with concave portions.

12. A member with convex portions manufactured using the method defined by claim 9.

13. The member with convex portions as claimed in claim 12, wherein the member with convex portions is formed of a material having transparency.

14. A transmission screen comprising:
a Fresnel lens formed with a plurality of concentric prisms on one major surface thereof, the one major surface of the Fresnel lens constituting an emission surface thereof; and
the member with convex portions defined by claim 12, the member with convex portions being arranged on the side of the emission surface of the Fresnel lens so that one major surface thereof on which the plurality of convex portions have been formed faces the Fresnel lens.

15. A rear projection comprising the transmission screen defined by claim 14.
